(19) United States
(12) Patent Application Publication
(10) Pub. No.: US 2011/0225064 A1
(43) Pub. Date: Sep. 15, 2011

(54) METHODS AND SYSTEMS FOR USING UNIVERSALLY UNIQUE ITEM IDENTIFIERS

(76) Inventor: Augustine Fou, New York, NY (US)

(21) Appl. No.: 13/114,372

(22) Filed: May 24, 2011

Related U.S. Application Data
(63) Continuation-in-part of application No. 11/811,468, filed on Jun. 11, 2007, now abandoned.
Application No. 11/811,468 is a continuation-in-part of application No. 10/653,391, filed on Sep. 2, 2003, now abandoned.
(60) Provisional application No. 60/812,290, filed on Jun. 9, 2006.

(51) Int. Cl. G06Q 20/00; G06Q 30/00

(52) U.S. Cl. 705/26.41

(57) ABSTRACT

Methods and systems for facilitating commercial programs involving consumer products using universally unique item identifiers (UUIIs) include supplying pluralities of universally unique item identifiers to third parties that mat be affixed on a one-to-one basis to products or various other items, and replying to requests for information corresponding to the UUII or an item to which it is affixed.

### CROSS-REFERENCE TO RELATED APPLICATIONS

This application claims priority under 35 U.S.C. §120 as a continuation-in-part of U.S. patent application Ser. No. 11/811,468 entitled “METHOD AND SYSTEM FOR USING UNIVERSALLY UNIQUE ITEM IDENTIFIERS” filed in the name of Augustine Fou on Jun. 11, 2007, which in turn claims priority under 35 U.S.C. §119 to U.S. Provisional Patent Appl. Ser. No. 60/812,290 entitled “METHOD AND SYSTEM FOR MARKETING” filed in the name of Augustine Fou on Jun. 9, 2006, and which also claims priority under 35 U.S.C. §120 as a continuation-in-part of U.S. patent application Ser. No. 10/653,391 entitled “METHOD FOR FACILITATING COMMERCIAL PROGRAMS INVOLVING CONSUMER PRODUCTS USING UNIVERSALLY UNIQUE ITEM IDENTIFIERS” filed in the name of Augustine Fou on Sep. 2, 2003, the entirety of each of the foregoing priority applications hereby being incorporated by reference.

### TECHNICAL FIELD

This disclosure generally relates to data processing for specific applications, and in particular it relates to associating or dissociating plural articles having an identification code.

### BACKGROUND OF THE DISCLOSURE

Consumer products are typically labeled with universal product codes (“UPCs”). However UPC codes do not individually identify each item of product; instead, for example, one billion bottles of 20 oz. DIET PEPSI soft drinks will all bear the same UPC code. Therefore, UPC codes are used with great difficulty in commercial programs such as manufacturer's product recalls or online loyalty marketing programs. In a product recall, a consumer cannot easily ascertain whether an individual item of product in their possession is part of the recall, because it is not possible to distinguish one item from another of the same type and size, based on the UPC code. In an online loyalty marketing program, a consumer cannot easily prove that they purchased multiple items of product of the same type and size by typing in the UPC code online, because the UPC codes are all the same. Instead, consumers are forced to physically cut out part of the product or its packaging containing the UPC bar code and mail-in such cut-outs as proofs-of-purchase.

Radio frequency identifiers (“RFIDs”), or “smart tags” as they are popularly known, are used as advanced version(s) of the omnipresent UPC bar code. However, like the UPC code, these item identifiers do not uniquely identify each item of product. Other numbering or systems including the International Standard Book Numbering (“ISBN”) system, the International Standard Serial Numbering (“ISSN”) system, the European Article Numbering (“EAN”) system, and the Japanese Article Numbering (“JAN”) system also suffer the same deficiency.

Serial numbers have been applied to some higher-priced consumer products by manufacturers for use when services such as repair under warranty are required by consumers. However, they are typically created by the manufacturer of the product and are not necessarily universally unique. Hence they may be confused with serial numbers of other manufacturers. Furthermore, serial numbers are used with great difficulty by consumers requesting services since most manufacturers do not make a database of such numbers accessible to the public for verification. Instead, consumers must physically mail-in a product along with appropriate paperwork in order to receive such service.

Holograms, watermarks, engravings, etchings, or other indicia have been applied to some consumer products as means of proving their authenticity. However, such indicia are 1) inconvenient to use, 2) can be counterfeited, and 3) are not unique to an individual item (e.g. millions of VISA cards all bear the same eagle hologram). A consumer desiring to verify the authenticity of an item such as a baseball card does so with great difficulty—he must know the manufacturer of the card, how to access an authentic hologram for comparison, if available, and then visually compare the holograms.

Accordingly there is a need for a method for facilitating commercial programs involving consumer products using universally unique item identifiers, which cures certain deficiencies in the existing technologies.

VISA BUXX and other bank-issued payment cards were created for young customers or other customers who could not get a credit card of their own. These payment cards are usually requested by parents to be given to their children as allowance cards. The parents sign up for the card, enter into a contractual agreement with the issuing bank, and load funds onto the card by way of a credit card or direct debit from their bank account. The balance and transaction history of these cards are also accessible online so that the parents can charge up funds and track transaction history. The problem is that young consumers like their independence and do not like the fact that their parents keep track of their spending in detail.

It is generally known that there are over 500 million credit, debit, general purpose, retail, oil and other payment card accounts in the United States (hereafter called “cards”). Worldwide, the figure is almost 1 billion such cards. Typically, each authorized user of an account is issued a card: a physical plastic object with an embossed account number and cardholder name appearing on its face. Anti-counterfeiting indicia, such as holograms, photographs, ID numbers, or signatures, may also appear on the card to discourage wrongful usage. As a further deterrent to wrongful usage, card issuers have added 3-4 digit numbers to the cards and many retailers, especially online retailers, have started to require these numbers as proof that the customer has the card in-hand. These additional digits are not an effective security mechanism if the card itself is stolen. Due to the rapid proliferation of such payment cards, the security afforded by 16-digit account numbers is rapidly decreasing. In fact, it is also well known that 1) the first 6 digits represent the issuing bank and only the last 10 digits identify the card 2) it is easy to accidentally get someone else's card number by mistyping just a single digit, and 3) algorithms to calculate valid 16-digit account numbers are freely available online and anyone with a computer can generate such numbers easily.

Payment cards used also as rewards for employees, sales persons, and customers. In these cases, employers or marketers charge up funds onto the card for use by their employees, sales persons, or customers. These cards are simply given to the recipient as monetary rewards and are merely convenient alternatives to writing a check or depositing monetary rewards into the recipient's account. Also, once the funds are used up, the cards are no longer of any use and thus create a waste disposal challenge, if sufficient quantities of such cards are distributed.

In many popular marketing programs today, marketers attempt to incentivize certain actions on the part of their consumers by providing discounts on purchases for specific items. It is widely known that the frequency of such “sales” not only cheapen the perceived value of an item but also condition the behavior of consumers to buy only when a “sale” is going on. Other marketing programs such as loyalty programs use points or miles to incentivize loyalty without discounting a specific item or giving discounts towards a purchase. However, the challenge with such points systems is that most consumers find it difficult to understand what a point is worth or accumulate enough points in order to use them to get the reward for their purchases; therefore such systems are known to cause only a small lift in sales or increase in loyalty when deployed.

Finally, current bank and network policies do not allow issuing cards without at least one of: a cardmember's personal information, an amount to be loaded onto the card, an account associated with the card with a corresponding amount of available funds or a credit line. Also, technological limitations do not allow dynamic loading or unloading of funds on a payment card based on logical rules or triggers.

It is a common practice in advertising and marketing to run sweepstakes marketing programs with prizes in order to help increase sales of consumer products, food and beverage products, or consumer packaged goods. This is typically done by adding game pieces, codes, and/or sweepstakes details to the packaging of such products. Each game piece is typically preprinted with codes or words which tell the customer whether they are a winner or not. The problems associated with these types of marketing programs are widely known in the industry. These include duplication, forgery, manipulation, and other forms of fraud related to the game pieces themselves. Other problems include the challenge of calculating and reporting accurate odds of winning and the number of winners because it depends on the number of prizes, the number of game pieces, the flow of product into distribution during the promotional period, and the number of total participants in the program. For example, in a widely publicized scandal that cost MCDONALD'S CORPORATION nearly $20 million, an employee of the company that administered MCDONALD'S MONOPOLY GAME AND SWEEPSTAKES in 2001 was caught stealing winning game pieces and having family members claim the prizes, including the grand prize. This was possible because all of the prize winning statuses—e.g. “you have won a prize” were printed on the game pieces. Although standard security precautions are taken, such fraud is still eminently possible when the prize winning message is printed on the game piece and the game piece itself is to be mailed in as the proof of such winning

In another example, MCDONALD'S 2003 BEST CHANCE GAME was so popular that McDonald's ran out of the 250 million game pieces printed for the program well before the end of the promotional period, as stated in the rules. Again, because prizewinning statuses and prizes were printed on the game pieces themselves, MCDONALD'S could not print and make available any additional game pieces because that would change the odds of the entire game, as stated in the rules.

In yet another example, PEPSI'S ITUNES promotion with APPLE COMPUTER in 2004 proved to be a major disaster when it was discovered that customers could easily tell if the bottle was not a winner, simply by tilting the 20 oz. bottle to a 20 degree angle to reveal part of the phrase “please try again” underneath the bottle cap. The winning bottle caps were printed with a claim code which could be used to claim a free ITUNES download. Again, because prizewinning statuses and prizes (the claim codes) were printed on the bottle caps, the program was easily compromised and thus rendered completed useless with respect to the objective of the program, which is typically to incentivize customers to make more purchases.

Further, the process of determining and proving prizewinning status is often laborious and inefficient, involving steps such as mailing-in game pieces for validation, looking up winning game piece codes against a database of winning codes, and others. Even the awarding of the prize is inefficient, often requiring the administrator of the program to send the prize to the winner by postal mail or otherwise deliver by hand.

Finally, the problem of irretrievability is inherent to any sweepstakes program where prizewinning statuses and prizes are printed onto game pieces or items of product. Specifically, this means, once the game pieces or products are distributed into circulation they cannot be retrieved easily. Thus the liability for all of the prizes associated with all of the winning game pieces and products remains with the administrator of the marketing program because the administrator will have 1) no way of knowing whether a winning game piece was discarded, destroyed, or still “in play” and 2) no way of marking the game pieces as no longer valid. The program administrator must wait until the end of the promotional period and the end of the game, which could be many months later, depending on how many months are allocated for prizewinners to claim their prizes.

Credit cards and debit cards have proliferated to the point that there are an estimated one billion general purpose cards including gift cards which use the standard 16-digit card number. It is generally known that credit card fraud has been increasing for years and with more and more payments being made online and credit card numbers stored by online merchants, widely publicized “break-ins” have been reported where millions of credit card numbers are stolen or compromised.

Credit card companies have scrambled to add security measures to mitigate such fraud. For example, (1) they have added three- or four-digit card identifiers (CIDs) to the cards and merchants are requiring customers to enter these extra digits to prove they have the card in hand. However, these extra digits are useless for maintaining security when the card itself is stolen. (2) Debit card personal identification numbers (“PINs”) are not very secure since they rarely change, are very short numeric sequences, and can be guessed relatively easily. (3) Radio-frequency identifiers (RFIDs) have recently been added to credit and debit cards as a means of “contactless” transaction where the card does not need to be swiped through a reader, but rather waved in front of a radio-frequency reader. This raises the possibility that a customer's card is read accidentally or worse yet a thief can “skim” the information from the card remotely without even obtaining it. Finally, (4) systems such as VERIFIED BY VISA and MASTERCARD SECURECODE include extra passwords that are added to a user account for online purchases. The user must enter the additional password to complete an online transaction.

None of these additional measures, however, offer useful fraud prevention without additional undue burden on the customer in setting up such measures.

There are various short-comings with present marketing tools involving promotional codes that are addressed herein. In particular, such marketing tools can only be utilized for limited time periods before over-familiarity diminishes their effectiveness. For example, code-based promotions are typically one-off events, which, once completed, have no further utility in terms of marketing the product. For a finite period of time, awareness of the product may be raised, but once the promotion has come to an end, the future sales of the product are effectively reliant on past consumer adoption activity.

Online environments, such as video games and online virtual worlds, have been continuously growing in popularity. While the potential for marketing promotions using such online environments is technically feasible, there have been no substantial efforts to date to harness this potential.

Currently, it is well known that counterfeit drugs are entering the prescription drug supply at alarming rates, leading to massive losses and liability of lawsuits against pharmaceutical companies, skyrocketing insurance claims, and public health costs. New laws proposed to help stem this tide, such as the Prescription Drug Marketing Act that has “electronic pedigree” requirements for tracking pharmaceutical chains of custody, are deemed to be too costly and impractical to implement.

Some pharmaceutical companies are experimenting with putting RFID (radio-frequency identifiers) on units of prescription drugs. However, this is costly on a per unit basis, requires specialized RFID readers, and requires pharmacists to take time out to spot check drugs in order to be effective.

Accordingly, there is a need for a method for authenticating products, such as pharmaceuticals, which is easily implemented and effective to identify counterfeit products to consumers, product manufacturers, distributors and law enforcement authorities.

Small businesses represent 99.7% of the number of businesses in the United States, an estimated $4.7 trillion in total spending, as well as one-third of all expenditures by businesses (source: Visa), adding 75% of net new jobs to the economy (source: Small Business Administration). The largest share of small business expenditures, 34 percent or approximately $1.6 trillion, is comprised of payments for “core business services,” such as legal, accounting, insurance and shipping and mailing expenditures.

However, credit cards account for only 3% of all small business spending overall, with the remaining 97% being transacted by cash and check. Divisions of companies, like OPEN from AMERICAN EXPRESS, or companies focused entirely on small business credit cards, such as ADVANTA, have seen incredible growth over the last several years in issuing small business cards relative to consumer cards, the market for which is massively oversaturated. Despite this recent growth, small business issuers are finding it increasingly difficult to shift spending away from cash and check, not to mention the increasing competition from other banks entering this lucrative market with small business cards of their own. To maintain the torrid growth rates, issuers are aggressively increasing spending in marketing and reward programs to attract new customers and increase transaction volume. The costs of these activities are ultimately passed on to card-members in the form of increased fees, such as annual fees, penalties, transaction fees, finance charges, and the like. This most acutely affects small businesses, especially those whose margins and cash flow are tight.

There is also an intense recent public awareness of identity theft, credit card and check fraud, online scams, and computer attacks such as viruses, phishing, and pharming. Many high profile news items, like the recent reports of 40 million credit card numbers being stolen, are causing consumers and small businesses alike to look for ways to protect themselves. Companies that provide services like identity theft protection and credit bureau monitoring have seen a corresponding boom. However, the risk of fraud remains high with one of the most common transaction methods: paper checks. Checking account numbers and bank routing numbers plus complete mailing addresses are printed in human-readable format on every check. This poses a gaping security loophole, especially in light of recent reports of rings of thieves whose modus operandi is stealing letters with checks inside from mailboxes or directly from postal facilities.

Accordingly, there is a need for a system for accomplishing financial transactions, such as those normally conducted by paper check, which is easily implemented in the commercial marketplace and readily useful by payer and payees of financial transactions.

In view of the foregoing, there is a need for methods and systems for using universally unique item identifiers (UUIIs) or universally unique identifiers (UUIs) as described herein that address certain problems of existing technologies outlined above.

### SUMMARY OF THE DISCLOSURE

The processes of the present disclosure commences when a customer presents a transaction payment instrument, such as a credit or debit card, at a point of sale, such as at a retail location or during an online transaction. The card is swiped, scanned, or payment instrument information is otherwise read or obtained by the point of sale equipment and transaction information is transmitted to a financial payment network, typically via a web server or the like. The details of this information are used to retrieve other information about the customer, such as the customer's cell phone number or other point of contact and security information stored for the customer. A request is sent to the customer via the point of contact, typically for an affirmative approval of the transaction and including a request for additional information. The customer must respond and supply this approval and the correct additional information in order to self-approve the payment.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a flow chart depicting a first method for facilitating a commercial program;

FIG. 2 is a flow chart depicting a second method for facilitating a commercial program;

FIG. 3 is a flow chart depicting a third method for facilitating a commercial program;

FIG. 4 is a flow chart depicting a fourth method for facilitating a commercial program;

FIG. 5 is a flow chart depicting a fifth method for facilitating a commercial program;

FIG. 6 is a flow chart depicting a sixth method for facilitating a commercial program;

FIG. 7 is a flow chart of a method 310 to cause a purchase by a customer by randomly loading prize funds onto a payment card;

FIG. 8 is a flow chart of the method 320 to cause a purchase by a customer by adding bonus funds onto a payment card based on the funds added by a customer;

FIG. 9 is a flow chart of the method 330 to cause a purchase by a customer by providing a secure payment card which does not disclose sensitive account or customer information during the purchase transaction and requires the customer to confirm the authorization of the purchase in a subsequent step;

FIG. 10 is a flow chart of the method 340 to cause a purchase by a customer by providing a payment card with a universally unique identifier for purchase offline to effect payment for a subsequent online purchase;

FIG. 11 is a flow chart of the method 350 to cause a purchase by a customer by providing a payment card with a universally unique identifier which serves as proof of their payment for prepaid services;

FIG. 12 is a flow chart of the method 360 to cause a purchase by a customer by adding bonus funds onto a payment card from a pool funded by participating marketers when the customer selects where he/she intends to spend the funds;

FIG. 13 is a flow chart of the method 370 to cause a purchase by a customer by giving customers a payment card with a universally unique identifier which they use to subsequently specify a delivery address to which their purchase is to be directly shipped;

FIG. 14 is a flow chart of the method 410 for determining prizewinning status using a code obtained from an item, such as a consumer product;

FIG. 15 is a flow chart of the method 420 for determining prizewinning status using a code not obtained from an item;

FIG. 16 is a flowchart depicting an exemplary process 610 for self-authenticated financial transactions according to the present disclosure;

FIG. 17 is a flowchart depicting an exemplary process 910 of using Universally Unique Item Identifiers (UUIIs) for continuous product promotion, according to the present disclosure;

FIG. 18 is a flowchart depicting an exemplary process 1010 of using Universally Unique Item Identifiers (UUIIs) to confirm the authenticity of a product, according to the present disclosure;

FIG. 19 is a flowchart depicting an exemplary transaction process 1210 performed by a payer, according to the present disclosure;

FIG. 20 is a flowchart depicting an exemplary transaction process 1220 performed by a payee, according to the present disclosure;

FIG. 21 is an exemplary screen for registering a customer for the transaction processes of FIGS. 19 and 20;

FIG. 22 is an exemplary screen for initiating a payment in accordance with the transaction process of FIG. 19;

FIG. 23 is an exemplary screen for making a deposit in accordance with the transaction process of FIG. 20; and

FIG. 24 depicts an exemplary computer network 1400 and exemplary computer devices 1450 with which the processes of the present disclosure may be accomplished.

### DETAILED DESCRIPTION OF THE SPECIFIC EMBODIMENTS

Methods for facilitating a commercial program as provided herein use a universally unique item identifier which differs from known uniform product codes and serial numbers because it is a combination of a pseudo-random number and an indication of time. It should be readily appreciated that the pseudo-random number may be generated in any manner including use of a pseudo-random number generating software or hardware, or by randomly selecting non-random sequences of consecutive numeric or alphanumeric codes, or in any of a wide variety of known manners.

The present disclosure discloses methods for facilitating commercial programs involving consumer products using universally unique item identifiers (“UUII”) or universally unique identifiers (UUIs), which terms are interchangeable herein. UUIIs differ from known uniform product codes (such as SKU codes) and product serial numbers because they include encoded information, such as a pseudo-random number applied to a particular product, and an indication of a time at which the pseudo-random code was generated. Since time is known never to repeat itself, the universal uniqueness of the alphanumeric string is ensured. Hence, each individual UUII code is unique and never repeats over time, which provides significant advantages as described herein. The UUII may thus be decoded to determine a corresponding product and the time of generation (which, in turn, provides an indication of the general timeframe of the purchase of the product).

UUIIs are generated by combining at least one of a universally unique element such as an indication of time, a serialized number and/or an alphanumeric code which serves as a key that identifies and unlocks particular information in a data store, and a “salt” which determines one of a plurality of algorithms used to encode or encrypt the combined entity/number used to form the UUII. A salt is a random unique string of characters that is added in to generate the hash. “Salting” passwords or other information is a security programming technique that guarantees, for example, that two users with the same password won't have the same generated hash used to access private data of the users and the like. A salt may be a random string with which a password is encoded. For example if the user's password is abc and it is encoded by the character string ‘123,’ an attacker could break it by simply trying out well-known, brute-force attack mechanisms. But if a salt is added, then an attacker has to find crack the user's password AND identify the correct salt used to encode the password, a longer string of data that makes it exponentially more complex to decode by unauthorized persons. One could randomize the salt every time a data string is encoded for even more security as long as the salt is saved for reference by authorized servers.

UUIIs provide many technological advantages over prior technologies. They secure information transferred between parties, while storing particular information within the UUII code that can be decoded and or verified in various manners as described herein. Of particular advantage is the fact that by storing a UUII and the hash or other manner of decoding it, information that is stored in the UUII can be readily retrieved and does not need to be stored separately and less securely in additional databases. This saves storage space, processing time, data retrieval time and optimizes a variety of other computer processing and data transfer functions.

UUIIs may be generated and supplied to or by third parties, such as manufacturers of consumer products, for affixing to items in order to individually identify each item. The information in the UUII may be used by business to analyze and monitor their commercial marketing programs corresponding to the product. A benefit of UUIIs to purchasers, consumers, and users of consumer products is the ease and efficiency of participating in commercial programs such as product recall programs, product usage research programs, and self-service item authentication programs.

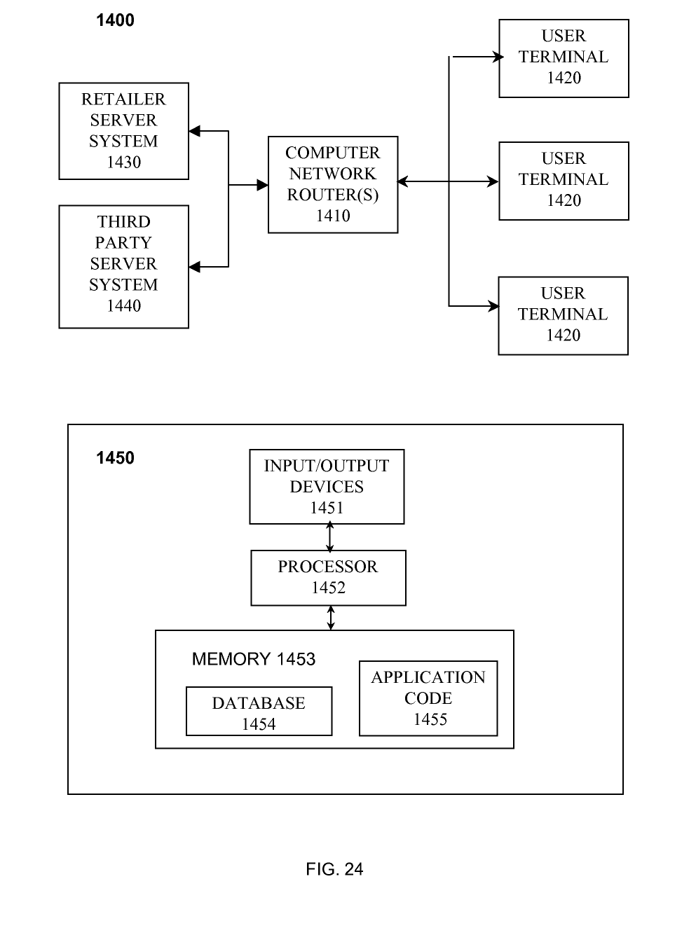

Referring first to FIG. 24, therein are depicted an exemplary computer network 1400 and exemplary components of a user device 1450 that may be used to accomplish the processes of the present disclosure The exemplary computer network 1400 includes one or more computer network routers 1410 that allow electronic communication of data between user computing devices 1420 and any number of other servers, such as a retail server system 1430 or a third party server system 1440, as are referenced in various forms herein. The computer network 1400 may be any type of wired or wireless computer network, including local area, wide area, fiber optic, electronic data or voice communications network, or a world-wide network such as the Internet. The computer network routers 1410 and server systems 1430 and 1440 each may be any enterprise class or local server computer system (of the type commonly manufactured by IBM) that can accomplish the data communications required herein. The user terminals 1420 may be any computing and/or communication device that may be used by a user to access a network 1400. Accordingly, user terminals 1420 may be a personal computer, a laptop or notebook computer, a personal digital assistant (PDA), a cellphone or smartphone (such as a BLACKBERRY OR IPHONE), or any other device with similar or equivalent functionalities.

An exemplary user device 1450 may be used as user terminals 1420, and the descriptions of the components thereof are likewise applicable to other computer systems described herein. The user device 1450 is useful for accomplishing data and/or voice communications required herein to accomplish the actions attributed to a user in the following descriptions. Accordingly, the user device includes input/output (I/O) devices 1451, one or more processors 1452, a memory or data store 1453 that stores data in the form of databases 1454 and application code 1455. I/O devices 1451 may include keyboards, touch-screens, microphones, speakers, visual display monitors, modems and necessary well known computer circuitry, as well as any useful equivalent thereof, for accomplishing data communications in the manners described herein. The processors 1452 may be any processor, such as of the type commonly manufactured by AMD or INTEL. The memory 1453 may be any one or more of random access memory, read-only memory, hard disc drives, optical or magnetic storage media and appropriate media readers, or the like. The databases 1454 may be any data structures useful for storing and retrieving the data described herein. Application code 1455 may include any processing instructions, operating systems, or computer programs that are well known and widely available for accomplishing the functions described herein.

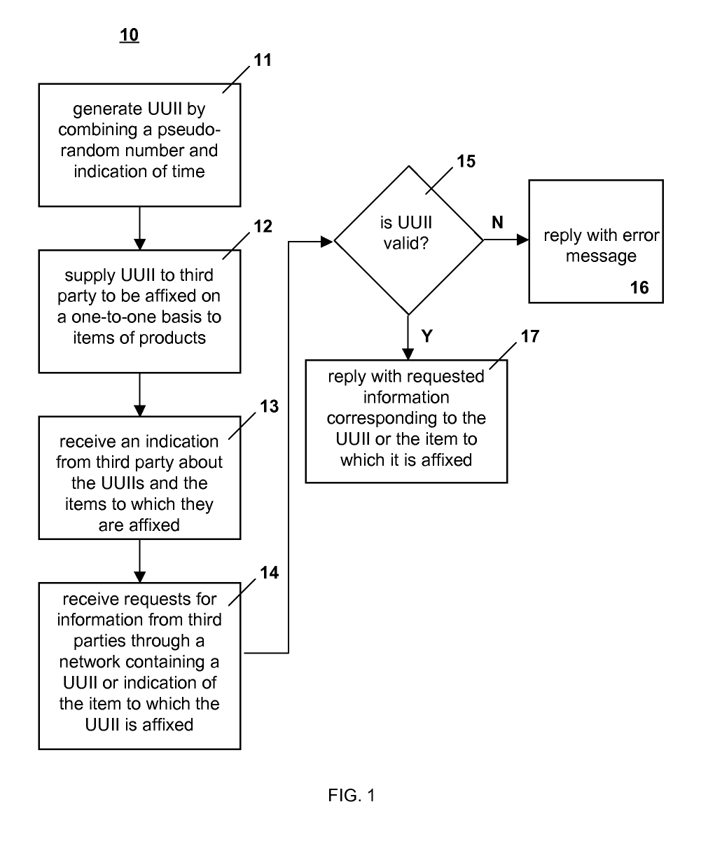

Against this technical background, the uses of UUIIs and UUIs in various commercial programs shall now be illustrated. Referring first to FIG. 1, a method 10 for facilitating a commercial program begins when an alphanumeric string is generated by combining a pseudo-random number and an indication of time (step 11). The UUII is then supplied to a third party (step 12), such as a manufacturer of consumer products, to be affixed on a one-to-one basis to items of product in order to individually and uniquely identify each item. Since time is known never to repeat itself, the universal uniqueness of the alphanumeric string is ensured. Then an indication of the UUII and the item to which it is affixed is received from said third party after the UUII is affixed and recorded (step 13). At any time thereafter, requests for information can be received from any third party such as consumers through a network such as the Internet (step 14) which contains a UUII or an indication of the item to which the UUII is affixed. In step 15, the UUII is validated and a proper reply to the request is selected. If the UUII is not valid, a reply containing an error message is sent (step 16). If the UUII is valid, then a reply containing information corresponding to the UUII is sent (step 17). The third party making the request for information may use this information to facilitate commercial programs.

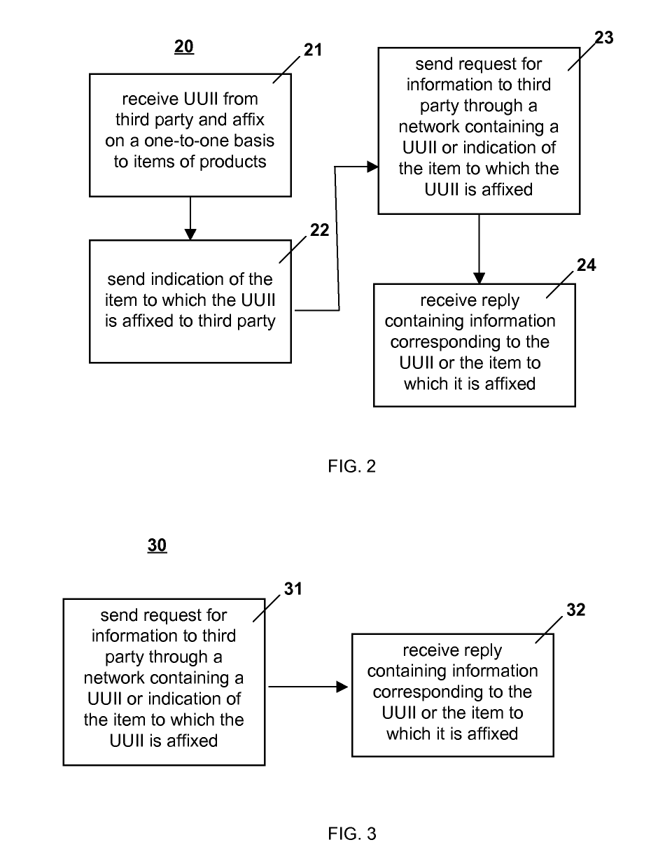

Referring now to FIG. 2, a method 20 for facilitating a commercial program begins when a manufacturer of consumer products receives a universally unique item identifier, in the form of an alphanumeric string, from a third-party and affixes the UUII to an individual item of product (step 21). The manufacturer may receive a plurality of UUIIs to be affixed to a plurality of items of product on a one-to-one basis such that each item is subsequently uniquely and individually identified. Once the UUII is affixed to an item, the manufacturer sends an indication of the item to which the UUII is affixed back to said third party (step 22). At any time thereafter, the manufacturer can send a request for information through a network such as the Internet (step 23) and receive a reply with information corresponding to the UUII which can be used to facilitate any commercial programs (step 24).

Referring now to FIG. 3, method 30 for facilitating a commercial program begins when a consumer sends a request for information to a third party through a network such as the Internet by supplying the UUII or some indication of the item to which the UUII is affixed (step 31). The consumer then receives a reply (step 32) with information corresponding to the UUII which can be used to facilitate any commercial program.

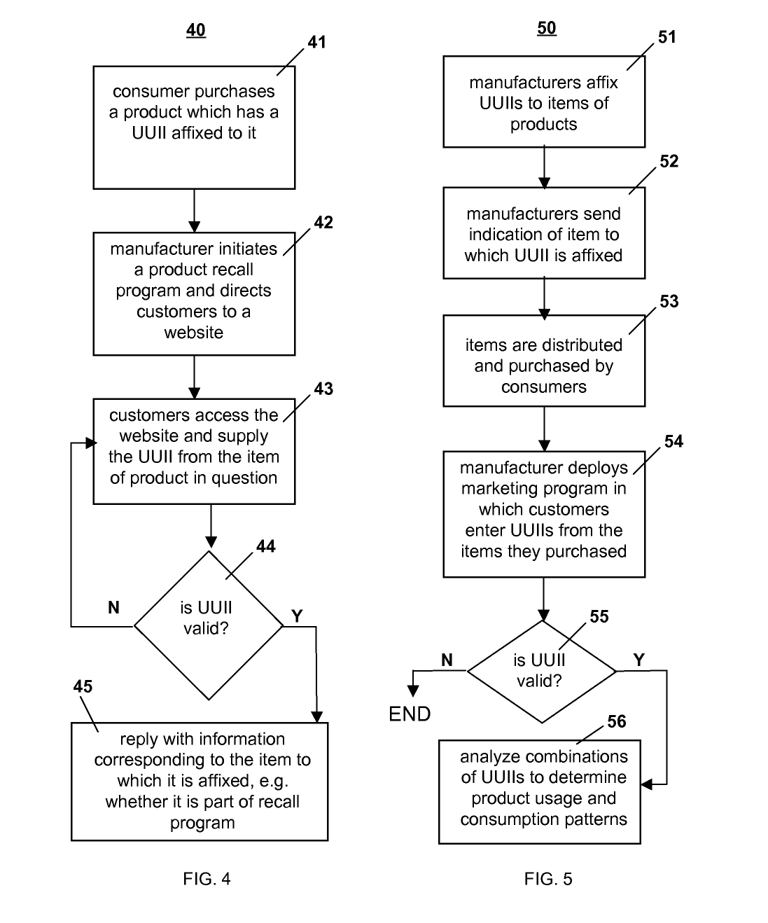

Referring now to FIG. 4, method 40 for facilitating a product recall program begins when a consumer purchases a product or several items of the same product (step 41). A manufacturer initiates a product recall by making public announcements, press releases, and advertisements through traditional channels such as print, radio, and television, which direct consumers to a specific website (step 42). The consumer accesses the website and supplies the UUII from an item of product (step 43). If the UUII is valid (step 44), information corresponding to the item to which it is affixed is immediately sent in reply (step 45). Since the UUII is universally unique, the information sent in reply will be absolutely unique to the item and may include when the item was manufactured, where the item was manufactured, and whether the item is part of the product recall. In this way, method 40 dramatically increases the efficiency of a product recall program, because it eliminates all of the steps a consumer would otherwise have to perform in order to ascertain whether the item of product in their possession is part of the recall.

Referring now to FIG. 5, method 50 for facilitating a product usage research program begins when manufacturers affix large numbers of UUIIs on a one-to-one basis to items of products that they manufacture (step 51). They then send an indication of the items to which the UUIIs are affixed (step 52). In step 53, the said items are distributed and purchased by consumers. In step 54, one or more marketing programs are deployed by said manufacturers, in which consumers of the product are asked to participate by entering in the UUIIs which are affixed to the items they purchased at a website dedicated to the marketing program. Since UUIIs are universally unique, it is possible to determine instantly what item was purchased by the consumer simply by the UUII, once it is determined to be valid (step 55). By analyzing the combinations of UUIIs supplied by consumers and the items of products to which they correspond, manufacturers will have a more efficient way to determine product usage patterns, including the numbers of items used or consumed but which are indistinguishable by type, size, or UPC code. In this way, method 50 dramatically increases the efficiency of a product usage research program, because it enables unique tracking of items purchased and consumed, without any labor or cost on the part of the consumer (e.g. mailing in proofs-of-purchase) or on the part of the manufacturer (e.g. handling mailed in proofs-of-purchase).

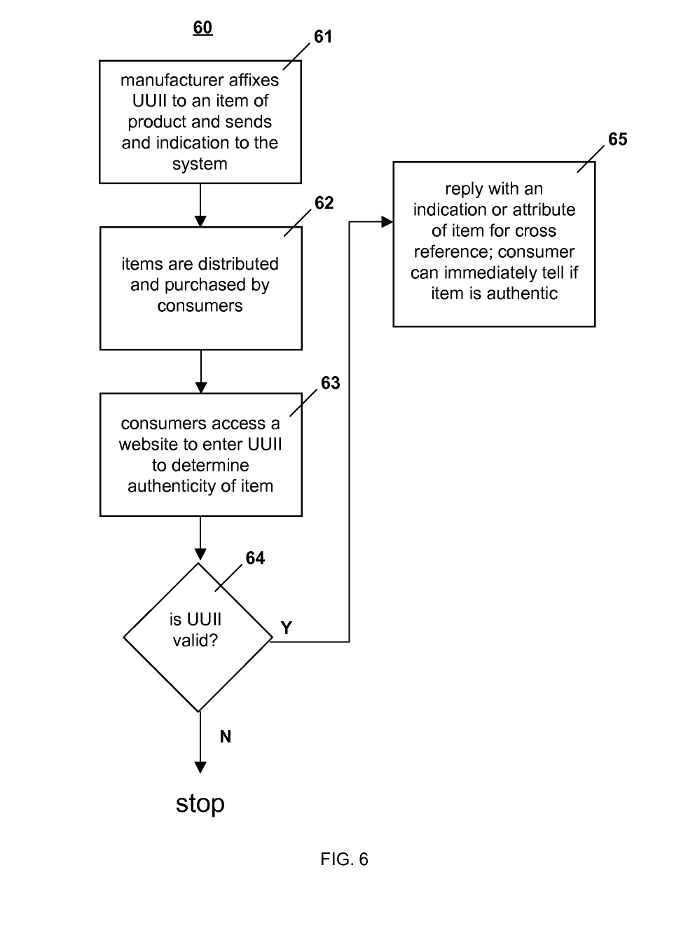

Referring now to FIG. 6, method 60 for facilitating a self-service item authentication program begins when a manufacturer of a product affixes a UUII to an item of product and sends and indication of the item to which it is affixed to a third party (step 61). Items are distributed and purchased by consumers (step 62). If a consumer wants to verify the authenticity of the item, they simply access a website and enter the UUII (step 63). Since the UUII is universally unique, it can never appear on another item. So, if the UUII supplied by the consumer is valid (step 64), an indication or an attribute of the item can be sent in reply immediately (step 65). If this matches the item in hand, then it is absolute proof of the authenticity of the item. In this way, method 60 dramatically increases the efficiency of a self-service product authentication program, because it provides the customer instant verification and does so without any additional time, labor, or cost to the manufacturer.

A benefit to a third party such as a manufacturer of consumer products who adopts UUIIs is the dramatic increase in efficiency in commercial programs involving consumer products, saving time, labor, and money. A benefit of UUIIs to purchasers, consumers, and users of consumer products is the ease and efficiency of participating in commercial programs such as product recall programs, product usage research programs, and self-service item authentication programs.

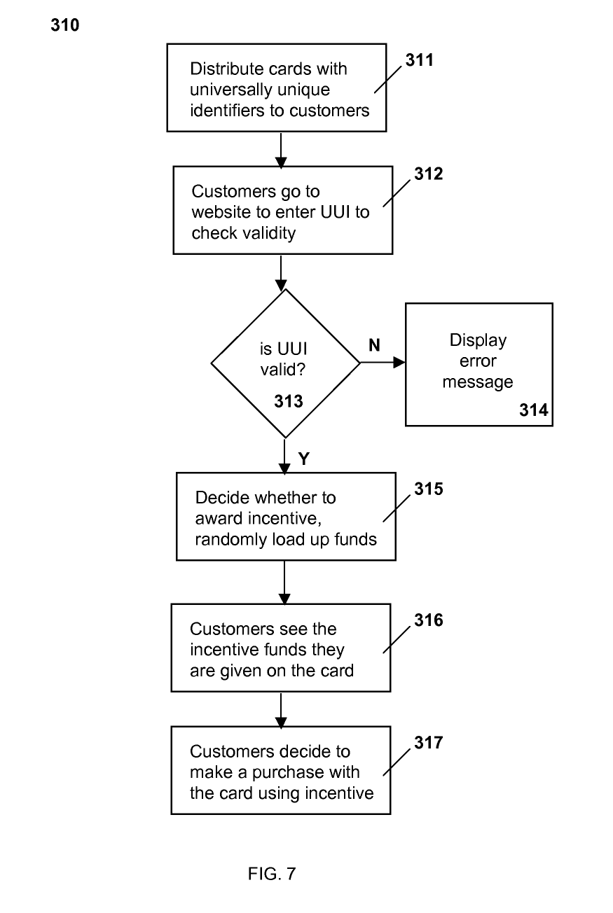

UUIIs can be utilized with payment cards in the following manners. Turning now to FIG. 7, there is depicted a method 310 for increasing sales or purchases in retail locations that is employed after a plurality of payment cards are distributed to consumers (step 311). Each card bears a universally unique identifier (UUI) created by combining a pseudo random number and an indication of time. Each card also carries instructions that direct the consumer to a particular website where they participate in the marketing program. Consumers visit the website at their convenience and enter the unique identifier in order to determine how to participate in the program and whether there are any funds loaded on their payment card (step 312). If the UUI is valid (step 313) they receive a message that instructs them that there is a specific amount of funds on their payment cards and that they must spend these funds at a specific retail location before the expiration of said funds. Different amounts of funds can be loaded onto different payment cards. These funds essentially serve as incentives for the consumer to spend towards a purchase. Different consumers may perceive the different amounts of funds as incentives to a greater or lesser extent and therefore they may or may not take action as a result of such incentive (step 315). Whether the consumer takes action or not as a result of the funds loaded onto their card is the basis of new consumer insights research about what motivates a particular consumer to make a particular purchase (step 316).

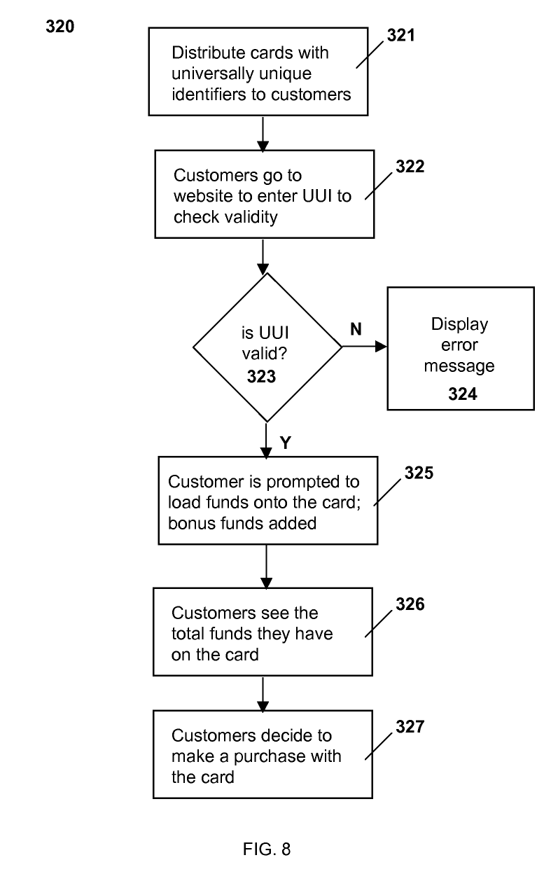

Turning now to FIG. 8, a method 320 for increasing sales or purchases in retail locations begins when a plurality of payment cards are distributed to consumers (step 321). Each card bears a universally unique identifier, created by combining a pseudo random number and an indication of time. Each card also carries instructions that direct the consumer to a particular website where they participate in the marketing programs. Consumers visit the website at any time at their convenience and enter the unique identifier in order to learn how to participate in the marketing program (step 322). If the UUI is valid (step 323), consumers typically receive a message which instructs them that if they were to load up specific amount of funds onto their cards, they would receive bonus funds to spend towards a purchase (step 325). For example, if the consumer loads up $50 onto their cards they would receive an extra $10, for a total value of $60 on their payment card. Furthermore a relatively short expiration time is designated in order to and courage spending of the funds in a timely manner towards a purchase (step 326-327).

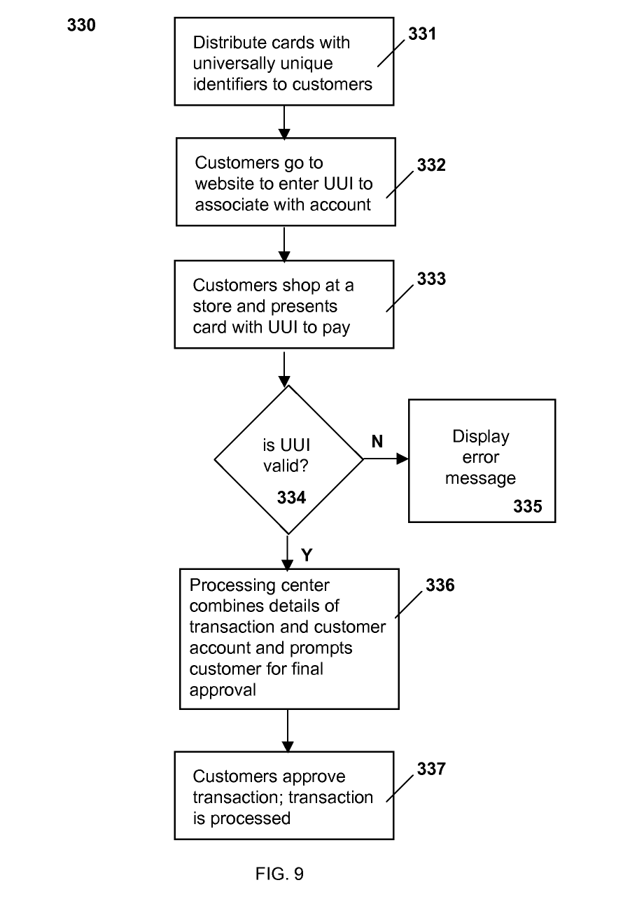

Referring now to FIG. 9, a method 330 for increasing the security of purchases by consumers using a payment card begins when a plurality of cards are distributed to consumers (sep 331). Each card bears a universally unique identifier, created by combining a pseudo random number and an indication of time. Consumers come online (step 333) to check the validity of the UUI (step 334) and to associate personal information and other payment-related information such as bank, credit or debit account information. At the time of the purchase the consumer presents this card in payment. The retailer swipes the card or enters the UUI into the point-of-sale equipment. The UUI is transmitted to a server, which translates it into a corresponding set of instructions to effect a transfer of funds from an account that is owned or controlled by the consumer making the purchase to an account that is owned or controlled by the retailer making the sale (steps 336-337). In this way, the consumer's personal and payment-related information are never disclosed to the retailer. This preserves the consumer's privacy, which in turn increases comfort level and purchases.

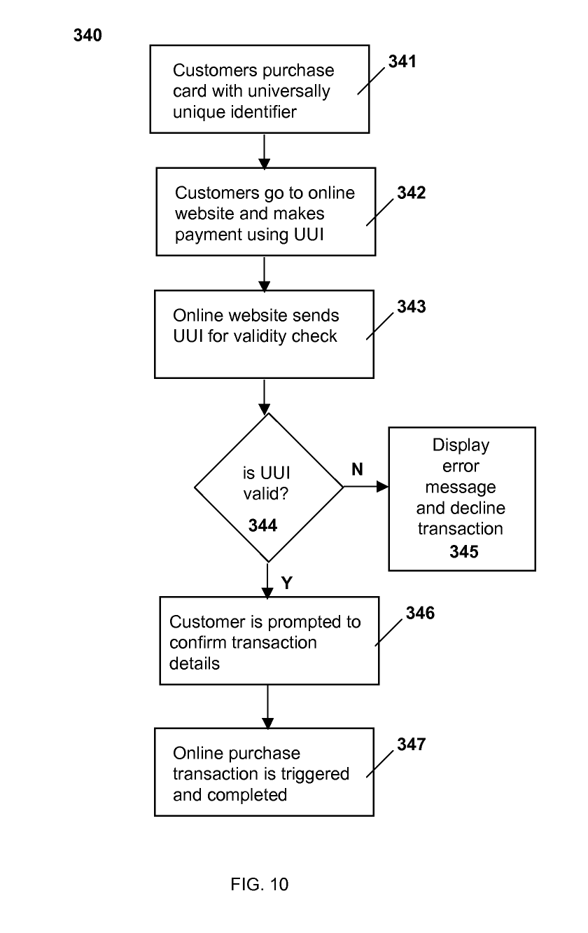

Referring to FIG. 10, a method of 340 for causing purchases by allowing customers to buy a payment card with cash offline, the universally unique identifier on which can be used to effect payment for an online purchase, begins when a customer buys a card with a universally unique identifier on it (step 341). They go online to make a purchase and present the UUI for payment (step 342). The online retail website transmits the UUI for validation and receives a message in return specifying the validity of the UUI (step 343) and the value of funds associated with it. The online retail website then decides to approve or decline the transaction based on the available funds associated with the UUI. If the transaction is approved and completed, the online retail website transmits the UUI and the corresponding transaction amount to receive the specified amount of funds (step 346-347).

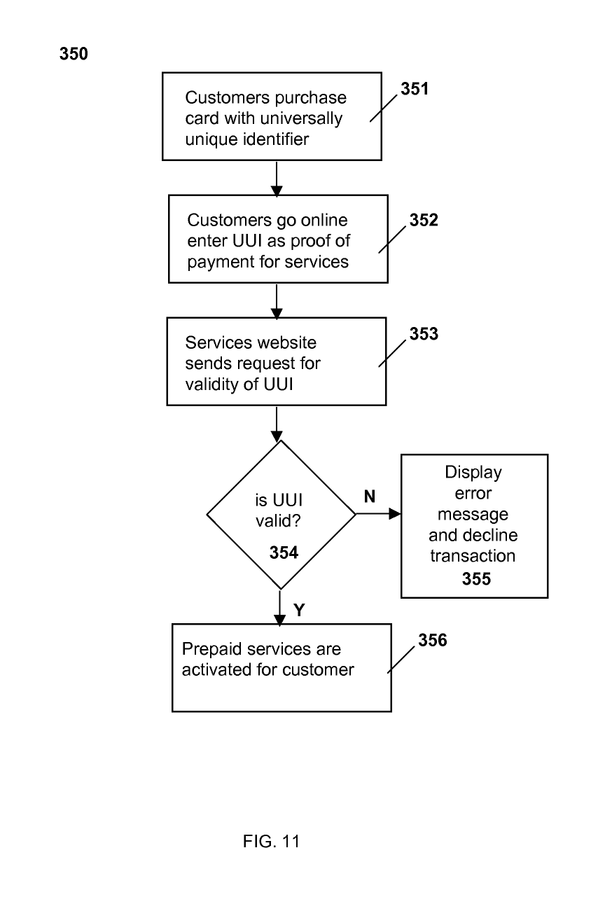

Turning to FIG. 11, a method of 350 for facilitating the transfer of funds from an individual consumer making payment into an account begins when a consumer purchases the card at the retail location with cash (step 351). Each card bears a universally unique identifier, created by combining a pseudo random number and an indication of time. Once the consumer completes the purchase they receive said card. Subsequently, they must go online in order to validate the purchase and activate said funds by logging into an account and entering said unique identifier from the card (step 352). Because said unique identifier is universally unique the exact amount of the purchase is immediately known and the correct amount of funds can be added into the corresponding account (steps 354, 356). The account can be any bank account or prepaid account, including prepaid telephone or wireless accounts. Alternatively the consumer can use SMS or text messaging on their mobile phones to enter the unique identifier in order to activate the funds.

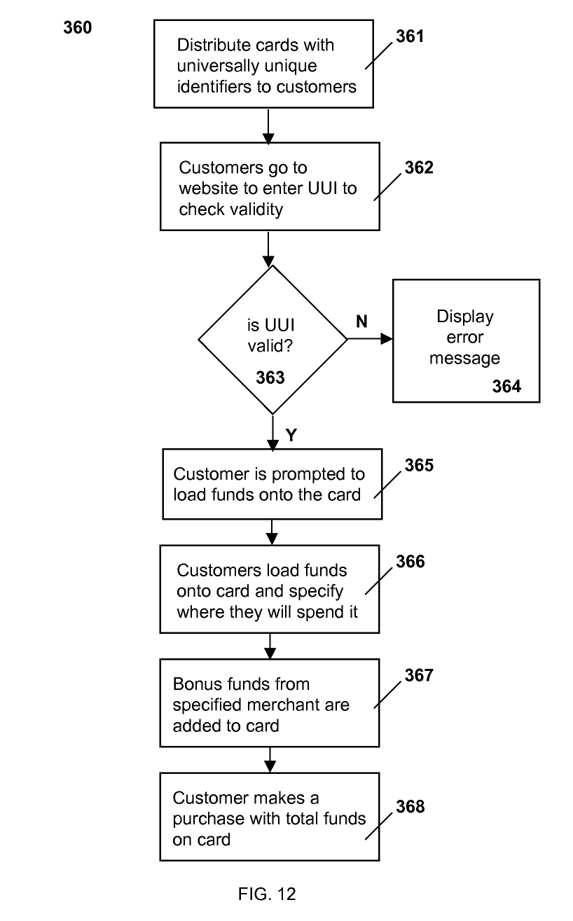

Turning now to FIG. 12, a method 360 for increasing the effectiveness of a marketing program begins when one or more marketers make payment into a pool of funds. Then a plurality of payment cards is distributed to consumers (step 361). Each card bears a universally unique identifier, created by combining a pseudo random number and an indication of time. Each card also carries instructions that direct the consumer to a particular website where they participate in the marketing programs. Consumers visit the website at any time at their convenience and enter the unique identifier in order to learn how to participate in the marketing program (step 362). Consumers typically receive a message that instructs them that if they were to load up specific amount of funds onto their cards, they would receive bonus funds to spend towards a purchase (step 365). For example, if the consumer loads up $50 onto their cards they would receive an extra $10, for a total value of $60 on their payment card. During the value load process, the consumer must select one of the retail locations, corresponding to one of the marketers participating in the marketing program, where they prefer to spend their funds (step 366). Once selected the payment card is fixed so that it can only be spent at the designated retail location. Furthermore, a relatively short expiration time is designated in order to and courage spending of the funds in a timely manner towards a purchase (steps 367-368).

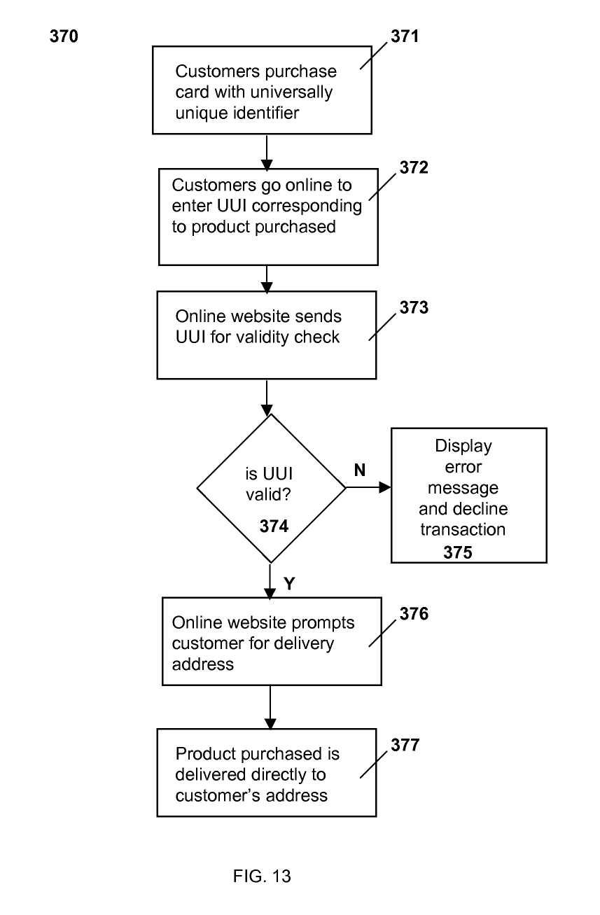

Referring to FIG. 13, a method 370 for increasing purchases of hard-to-ship items begins when a customer enters a retail location and peruses products on display (step 371). If they are interested in a product, they make payment at the register and receive a card, with a universally unique identifier on it, which represents the item they just purchased. They must then go online and enter the said unique identifier and specify a delivery address to which the item is to be shipped (step 372). The identifier, when combined with a purchaser-supplied delivery address, is translated into a set of instructions that not only effect the transfer of funds from an account owned or controlled by the purchaser to and account owned or controlled by the retailer, but also effects the shipment of the item to the purchaser from a regional warehouse (steps 376-377). The advantage of this invention is to dramatically lower the cost of retailing products, especially products which are large in size and weight. And it gives the purchaser a more pleasant experience since the item is delivered directly to their destination without their having to bring it with them right after the purchase.

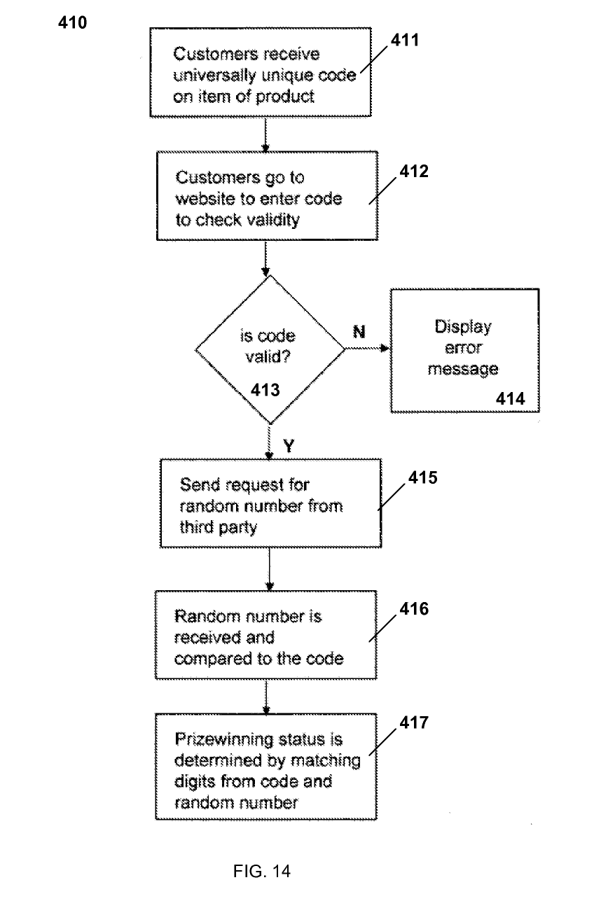

UUIIs and UUIs may be used in commercial programs, such as lotteries, prize give-aways, sweepstakes or the like, as illustrated in the following. Turning to FIG. 14, a method 410 for determining prizewinning status begins when a code, typically a number or alphanumeric string, is obtained from an item such as a consumer product (step 411). The code is entered online by the individual consumer at a website specified in the sweepstakes instructions (step 412). Once the code is received it is validated to be a genuine code that was initially applied by the manufacturer of the product to the game piece, product packaging, or the product itself (steps 413-414). If the code is valid, a request is sent to a third party through a network (step 415). The third party that receives such requests replies with a random number or an equivalent representation of said random number, such as an alphanumeric string (step 416). If this random number sent in reply matches one or more digits of the code entered by the consumer in accordance with the parameters of the marketing program, a determination is instantly made of prizewinning status (step 417). This determination can follow any logic, such as if the reply matches the code, then the status is “winner” or if specific digits of the reply matches the code, then the status is “winner.” The prizewinning status is never known prior to that moment in time when the valid code from the item is matched against the random number generated and returned by the third party. Then, if necessary, additional information may be collected from the consumer. This information may be used in selecting the prize that corresponds to the winning status. Finally, the prize is awarded. In a preferred embodiment, the prize is awarded instantly by displaying it or information related to it immediately to the consumer. If the prize is a cash prize, a credit card or debit card number is displayed on-screen along with information such as expiration date so that the customer has the instant gratification of receiving their prize and being able to spend it rather than having to mail in a game piece and wait for a paper check to be mailed to them.

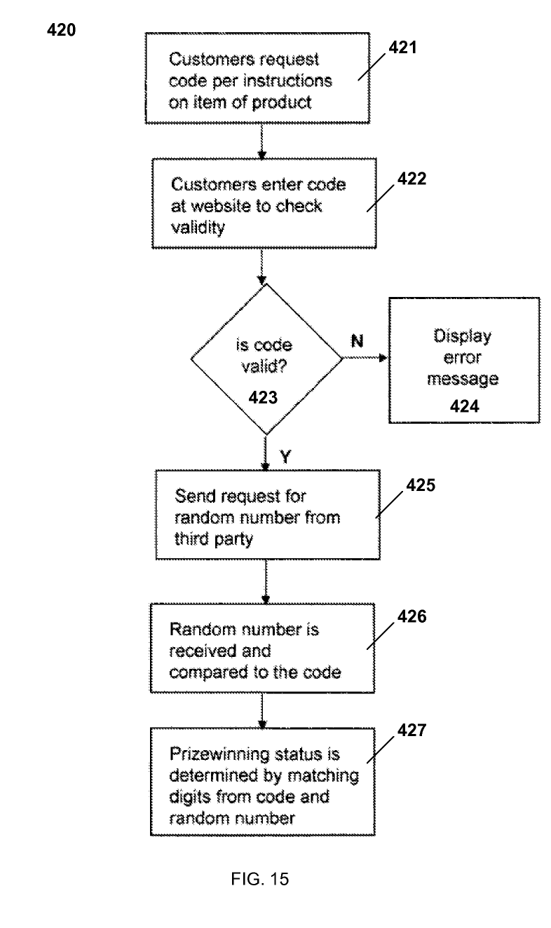

Turning to FIG. 15, a method 420 for determining prizewinning status begins when a customer is notified of a sweepstakes program involving a UUII by standard advertising and marketing methods (step 411). The customer goes online (step 412) to the specified website or sends an email to the specified email address to request a unique code for the game, typically a number or alphanumeric string. The code and other information, such as information about the customer, is entered online by the individual consumer at a website specified in the sweepstakes instructions. At that time, a request is sent to a third party through a network (step 415). The third party that receives such requests replies with a random number or an equivalent representation of said random number, such as an alphanumeric string (step 416). If this random number sent in reply matches one or more digits of the code entered by the consumer in accordance with the parameters of the marketing program, a determination is instantly made of prizewinning status (step 417). This determination can follow any logic—such as if the reply matches the code, then the status is “winner” or if specific digits of the reply matches the code, then the status is “winner.” The prizewinning status is never known prior to that moment in time when the code is matched against the random number generated and returned by the third party. Then, if necessary, additional information may be collected from the consumer. This information may be used in selecting the prize that corresponds to the winning status. Finally, the prize is awarded. In a preferred embodiment, the prize is awarded instantly by displaying it or information related to it immediately to the consumer. If the prize is a cash prize, a credit card or debit card number is displayed on-screen along with information such as expiration date so that the customer has the instant gratification of receiving their prize and being able to spend it rather than having to mail in a game piece and wait for a paper check to be mailed to them.

In this way, the processes 410, 420 eliminate fraud related to game pieces because duplicated, forged, or otherwise manipulated game pieces can never be fraudulently used to prove prizewinning status. The odds of prizewinning and the number of winners will no longer be dependent on the following variables: 1) number of prizes, 2) the number of game pieces, and 3) the number of participants in the marketing program. Further, customers will instantly and absolutely know their prizewinning status without having to mail in any game piece as proof. And finally, prizes are awarded instantly to the prizewinner without requiring the customer to mail in a game piece and wait to receive the prize in the mail.

The present disclosure further addresses many of the problems associated with the proposed new forms of security measures designed to prevent fraud and protect customers when they pay with, for example, a standard credit or debit card. The basic premise is that customers self-authorize payments by way of a real-time communication with them via a personal communications device, such as their cell phone. The communication is initiated after the commencement of the transaction, and the customer must correctly supply requested information during the communication before the transaction will be authorized. Customers are thereby easily empowered to help police for fraud and protect themselves on a transaction-by-transaction basis, with far greater efficacy than any of the elaborate systems that have been previously tested or deployed by financial institutions.

Financial institution, as used herein, may be in reference to banks, credit card issuers, credit card clearinghouses, third party payments processors such as PAYPAL, and any other type of entity that processes payment transactions for customers using any heretofore known or later-developed instrument that accomplishes payment for a transaction. The transaction may be between a customer and a merchant, or any other type of payment involving two or more parties, without limitation.

The transactions, as referenced herein, may be accomplished over any type of heretofore known or later-developed payment system used for accomplishing payment between two or more parties, without limitation. Examples include the NOVUS and CIRRUS networks and the internet or world wide web.

Communications between the financial institution and a customer, used for self-authenticating or self-approving a transaction as described herein, may take place over any of a wide variety of heretofore known or later-developed communications media that for facilitate an exchange of vocal and/or data communications between two or more parties, without limitation. For example, the financial institution may use existing automated computer processing systems, and, in various embodiments, in conjunction with interactive voice response units (IVRUs) or the like to contact a customer in any known manner. The IVRU may be directed to contact the customer at her desired point of contact, such as mobile (cellular or satellite) telephone number, land-line number, mobile web address, globally-accessible electronic mail account, instant messaging address, or the like. The point of contact may be selected and re-assigned by the customer in any of a variety of known manners, such as updating such information on a (secure) website of the financial institution, or by otherwise contacting the financial information with their selection, without limitation.

Customer information used for the security challenge during the communication between the financial institution and the customer may be any type of information that is preferably received in a secure manner from the customer and stored by the financial institution prior to the transaction. This may include well-known personal data that is now collected by financial institution's in the standard course, such as any of the customer's: first name, middle name, last name, street address, house number, zip code, primary home telephone number, daytime or work telephone number, cellular or satellite telephone number, electronic mail address, instant messaging address, social-security number, date of birth, and the like without limitation. The customer information may likewise include any other data that is requested by the financial institution and securely communicated by the customer, without limitation, and prior to a transaction.

The customer may respond vocally to the responses, which are recognized by the financial institution's IVRU or the like via well-known speech recognition software. The customer may likewise input information via a telephone keypad of a telephone, or a stylus or keyboard input to any other type of computing and/or communications device, without limitation.

In review, current financial approval processes are a two-way, point-to-point between the merchant server or point of sale terminal and the approving bank or network. It passes info like the credit card number, the amount of the potential transaction, etc. and the bank or network replies with an approval typically based on whether sufficient funds are available. The present disclosure alters previous financial transaction authorization processes by introducing a self-authorization system involving three end points: a financial transaction approval server, a merchant AND the customer who initiates the transaction. The steps introduced herein may typically happen before the step of verifying whether there are enough funds to cover the transaction. The self-authorize steps introduced herein ensure that not only is it the correct individual initiating the transaction, but that they positively confirm they want the transaction to happen. This may reduce what is known in the financial industry as charge-backs, which are when an individual later declares that they did not intend to perform a completed transaction. Charge-back incidence will be reduced because the customer in the present disclosure must authorize the transaction by providing a correct security response, while the transaction is pending or still in progress, i.e., before the final authorization of the transaction is provided by the financial transaction server to the merchant.

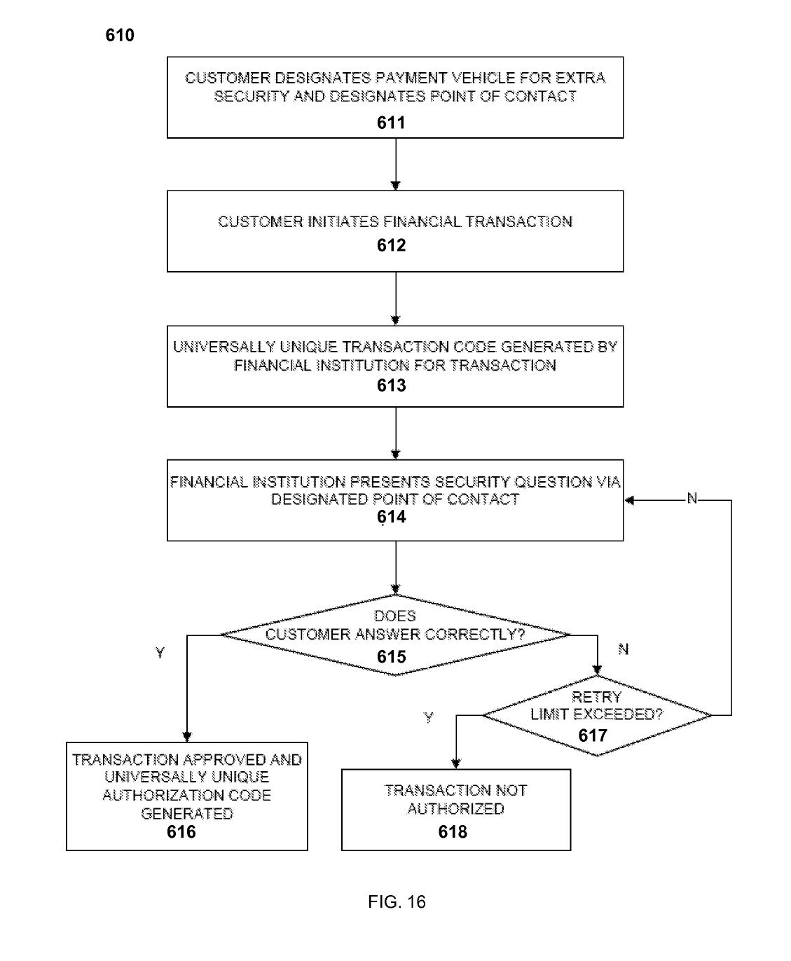

Referring now to FIG. 16, therein is depicted an exemplary process 610 for accomplishing a self-authenticated payment transaction, according to various embodiments described herein.

Prior to commencing any transactions, the customer designates a transaction payment instrument with the enhanced security measures described herein, and designates point of contact for receiving communications during a transaction (step 611). Because a transaction may be entered into anywhere, a customer will likely designate a mobile telephone, a BLACKBERRY device, or other mobile device without limitation. However, it is envisaged that the customer may select any point of contact information of their preference, and change it as desired thereafter. Customers may also add or update security challenge information prior to entering an initial, or any subsequent, transaction as desired.

Next, at step 612, the customer initiates a financial transaction. In response thereto, the financial institution is notified of the transaction, and as in the standard course, may be requested to authenticate and/or authorize the transaction by a merchant or the like. Unlike existing systems, however, the present processes provide the following enhancements.

First, in various embodiments, the transaction may be identified by a universally unique identifier (UUI) used by the financial institution to identify the transaction (step 613). UUIs differ from known transaction identification or authorization codes because they are generated to include encoded information, such location of a transaction, merchant name, merchant type, store identifier, or any other data known to be collected during an electronic financial transaction. The UUI is further encoded with an indication of a time and/or date at which the pseudo-random code was generated or the transaction was initiated, such information, in conjunction with the other encoded information, providing a code that is universally unique and nearly impossible to duplicate, determine in advance, or forge by malicious third parties.

Notwithstanding the foregoing, standard transaction identifiers, such as used in existing payment processing networks, may be used in place of UUIs in the processes described herein, should the further enhancement to security provided thereby not be desired.

Returning to the process 610, the financial institution next presents one or more security questions to the customer via her designated point of contact (step 614). Next, at step 615, it is determined whether the customer provided the correct response (step 615), such as by receiving and converting the customer response to a computer-readable format and comparing such data to that previously stored for the customer by the financial institution.

If the customer provides an incorrect response, one or more retries may be permitted (step 617), in which the customer is notified of the incorrect response, and then asked to submit a response to the same or a different security challenge. The retries may be permitted in case of an honest mistake by the customer in providing or entering the response, or in case of incorrect interpretation by the automated system of the financial institution. The number of retries may be limited though in order to prevent attempts at phishing or the like, and is contemplated to be zero, if a financial institution or a customer so selects. If the retry limit is exceeded without a correct response, the transaction is not authorized (step 618) and the process 610 ends. The unsuccessful transaction may be noted and flagged by a financial institution's security or operators for investigation or follow-up with the customer. This can be done in near real-time, if the institution has the manpower.

If, on the other hand, the customer provides a correct response or responses to the security challenge, the transaction may be authorized/approved immediately by the financial institution (step 616). The approval code used may include a UUI as described previously above, or may include any well-known type of authorization code. The financial institution may communicate the approval to the merchant in any well-known or hereafter developed manner, after which the transaction is processed in the standard course and the process 610 ends.

In one embodiment of the present disclosure, a voice call is made to the customer's cell phone at the moment their payment card is swiped at the point of sale, signaling the beginning of a purchase transaction. The cardholder answers the call and provides the bit of information that is being requested. This information is known to the cardholder customer (e.g. 4-digit birth year, 5-digit zip code, first 4 digits of social security number, street number of address, and the like). By providing this information correctly, they affirmatively self-approve the transaction. In such embodiments, if a thief were to attempt to commit fraud using the customer's card, the thief would have to also steal the communications device (cell phone, in this case) and correctly answer one of a number of randomly selected questions by supplying the requested bit of information.

In another preferred embodiment of the present disclosure, the customer initiates a transaction and a text message sequence is initiated to allow the customer to self-authorize the payment. Customers may in these and other embodiments, be engaged in a TEXT-TO-PAY transaction system or the like.

In another preferred embodiment of the present disclosure, the user initiates a transaction on an internet e-commerce site and receives the extra security of a self-authorized transaction, as described above.

The disclosed processes prevent various types of fraud, such as timed attacks. The random rotation of the request for information solves programmatic attacks. Contacting the customer directly in real-time solves phishing and pharming attacks that are commonly seen, for example, on the Internet. The fact that the information being requested is readily known by the customer solves the difficulty in remembering additional information that may be requested by a financial institution, such as in prior transaction security systems.

Additional marketing processes now introduced below involves two approaches that consumers are already familiar with, and combining them to extend their potential, thus creating a much more profound depth of interest, along with increased longevity. This, in turn, creates a significantly more powerful marketing tool, the time horizon for which is effectively determined by consumer interest in undertaking adventures in their selected virtual worlds. The first of these tools is the ‘premium’, the gift or toy or surprise that consumers have been finding in various products such as cereals, candy and so on for decades. The second tool is the UUII code that consumers can find after purchasing a product, and which is then utilized, via the Internet, to obtain a reward. Both of these marketing tools are by now so familiar to consumers that their effectiveness has been greatly reduced. By combining these two tools, such that the UUII code effectively becomes the proximate premium that the consumer then uses to obtain the ultimate premium, namely, an attribute or attributes in an online virtual environment, a new and exciting tool can be created which can set in motion a potentially endless marketing mechanism.

The process 910 resolves the problem that current marketing tools suffer from, namely, being effective for only finite periods of time, that now allows marketing for a single product (or combination of products) to run for a potentially unlimited period.

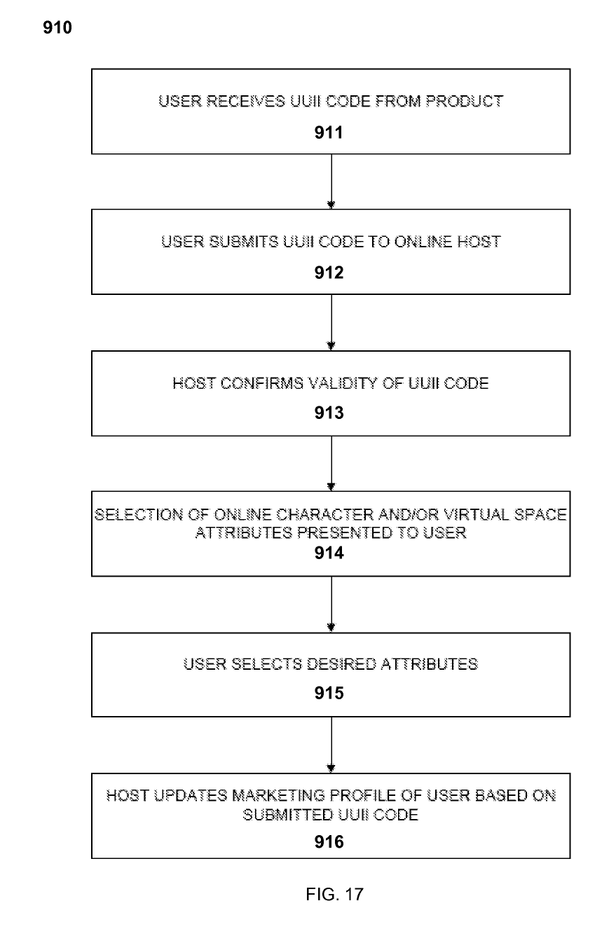

Referring now to FIG. 17, therein is disclosed an exemplary process 910 for using UUIIs to enhance marketing tools. UUIIs may be applied to products purchased by consumers or otherwise distributed to users (step 911). Valid UUIIs are matched to product SKU, batch numbers or product serial numbers of product to which they may be attached. A user will purchase a product, such as a box of cereal, and will find in or thereon a UUII code comprising, for example, alphanumeric characters. This combination of letters and numbers, in which each placeholder has the potential to be any one of 36 different characters, creates the potential for an unimaginably vast number of different codes. Each code will be universally unique, which means that no two consumers will ever share the same code, which, as will be readily apparent, is of use in the disclosed processes. With the code in hand, the player will then be directed to a website in which she can enter the code. The code can be thought of as being like a stretch of DNA, a double-helix sequence of rules and instructions for the building of a virtual character or space in the online environment, and this is what the player will ultimately use to commence or continue her adventure therein.

Continuing with the process 910 at step 912, the user may present the UUII to a host of an online environment that accepts such UUIIs. The host may operate a web server or the like, such as an enterprise server manufactured by IBM, having sufficient memory, processor, and operating and processing instructions to accomplish the functions described herein. The programming instructions may include information on how to decode UUIIs to obtain the underlying encoded information.

The host confirms the validity of the submitted UUII, for example, by referencing valid UUII information stored in a database in memory (step 913) and presents one or more attributes for the virtual environment that the user may apply to her virtual space or virtual character, as described hereinafter (step 914). The attributes may be dependent on the UUII submitted by the user, or may simply be a general set of all selectable attributes available. The user then selects and applies the selected attribute(s) (step 915). The host may then update a marketing profile of the user (step 916) to indicate the UUII, or information corresponding thereto, such as the product that was purchased and corresponds to the UUII, as well as approximate timeframe of purchase or any other information encoded by the UUII.

The online virtual character that is first created will have a certain amount of the following traits, all determined by the DNA sequence: power, intelligence, weapons, tools, shields, health, endurance and so on. Having first created the character, the player can then begin to explore and create a virtual world. But the player and her character will of course not be alone because she will be joined by a multitude of other characters all created in the same way. These characters will then be able to interact with each other in whatever ways they choose to do so, whether it be to enter into mortal combat, to seek to gain an advantage over others through cooperation and collaboration, or to adopt simple indifference towards each other, not even offering a simple ‘how do you do?’ as they pass by. And these characters may, in turn, create their own virtual worlds, and may each be connected to other spaces of other user in a three-dimensional virtual space. Users may customize their virtual space to include selected colors, sounds and images of their choice. There will literally be no boundaries to inhibit the potential for players to venture forth from one world to another, exploring and creating as they go.

Just as there will be no boundaries to the worlds which might be created, nor will the players' characters be limited. Players will be able to obtain new and more powerful tools, weapons, shields and the like by purchasing different products in the real world which will contain further DNA code sequences which, when applied, will open up these further possibilities.

The players will have to take care of their worlds however. Just as in the real world neglect leads to decline and decay, so too in the virtual world will players discover that it does not pay to be careless in how they go about tending to matters. If a world is too uninviting a place so that others do not care to visit it, it will begin to atrophy and wither and then it may finally expire, without additional enhancements that can be obtained from submitting further UUIIs. It should be noted that since each UUII is unique, a particular UUII may not be re-used by a consumer or shared between consumers, for such purposes.

The potential for this to function as a marketing tool is very great indeed. Unlike conventional marketing tools which are finite in the length of time for which they are useful before familiarity and boredom render them obsolete, by its very nature this marketing tool will always be fresh and exciting, filled with limitless potential for consumers to develop their characters and to explore different worlds. The most obvious target market for this tool is clearly younger people who would seek to influence parental purchase choices. It is possible, however, to envisage adults also finding these virtual worlds to be an exciting and welcome distraction from the concerns of the real world. As consumers become more attached to the characters that they create and develop, they will become ever more inclined to purchase the products that contain the UUII codes, so that they can maintain and or further enhance their virtual worlds.

By changing the products in which the codes are provided, the tool can be used to direct consumers from one product to another, helping to stimulate demand where it is required, for example, for the launch of a new product. Children (and many adults) have always played games, and in this high-tech age, this tool simply combines the adventurous and playful spirit of children with the available technology to create a powerful mechanism for attracting consumers.

Furthermore, UUIIs submitted by such users have the potential to generate additional revenue for the hosts of online environments that accept the UUIIs. The host, or other third party, may generate databases containing the UUIIs as submitted by the various users. The databases may include profile information of the user, such as name, personal information, age demographic and the like. The UUIIs submitted may be analyzed to determine the types of products that have been purchased. This information may be sold for marketing purposes, or used to determine other product promotions or cross-promotions that may be presented to the user, either in the online environment or by other means (e-mail, postal mail, telephone, and the like). The customer profile information may be compiled and presented in any of a wide variety of known formats, or those developed hereafter.

The present disclosure builds upon the methods for using universally unique item identifiers to determine whether a product has been counterfeited (e.g., a UUII on a product is determined to be false).

By printing human readable UUII codes on units of pharmaceuticals, for example, to uniquely identify each item, consumers, manufacturers and distributors can easily check the authenticity of the drugs for themselves by visiting the appropriate pharmaceutical company's website, or other globally-accessible network site, and entering the code. Consumers should be willing to spend the few minutes each to ensure their family member is not unknowingly taking counterfeit drugs. With potentially millions of consumers helping to check for and report such counterfeit drugs, the speed of detection of counterfeit products is greatly increased, and the entire pharmaceutical supply may thus be rendered much safer.

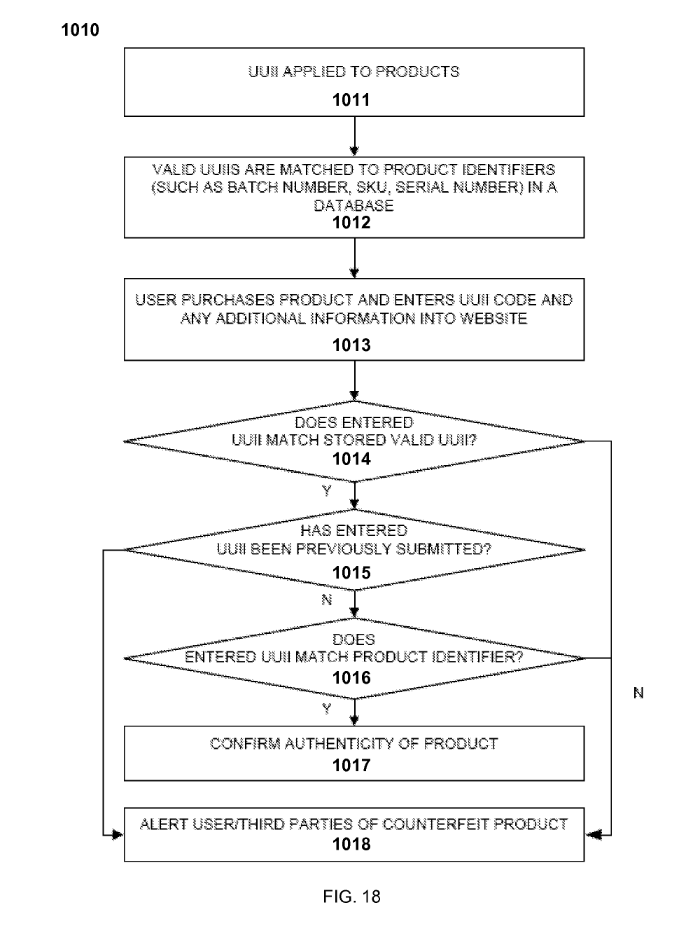

Referring now to FIG. 18, therein is disclosed an exemplary process 1010 for using UUIIs to authenticate products. In performing the process 1010, it should be readily apparent that the users and third party participants to the process 1010 may communicate over a computer network, such as the Internet, and that each party may use any of a wide variety of well known computer systems that include processors, memory, inputs/outputs, communications ports, and appropriate hardware and software, such as operating instructions, applications, databases and processing instructions for accomplishing the functions described herein.

The process 1010 begins when a party affixes a UUII code to an item of product (step 1011), which is then released for sale to the general public. The UUII includes a date/time stamp or the like that uniquely identifies, via any of a variety of encoding techniques, the time the UUII was generated and/or applied to the product or its packaging. Valid UUIIs are stored in a database or the like (step 1012) that matches an indication of the UUIIs, such as a batch, to an indication of the product, such as a product identifier (SKU, UPC, serial number) of the product to which it was applied for later confirmation when a UUII is submitted by a user for authentication of the product.

When members of the general public purchase the product, they come online to a website to determine whether the product is an authentic product (step 1013). They do so by entering the unique code which was originally affixed to the product by the manufacturer of the product. They may also enter in another piece of information that may identify their general location, such as a zip (or other postal) code, a city name, a telephone area code, a store from which the product was purchased, or the like. This piece of information, combined with the validity of the unique code and the date and time at which the code was validated, serves as a unique instance of the product being authenticated, which in turn is used to determine the authenticity of the product as described later below.

Continuing with the process 1010, the UUII received from the user in step 1013 is compared to an indication of valid UUIIs (step 1014). If the UUII is a valid UUII, the process 1010 continues to step 1015 below. Otherwise, if the UUII is not a valid UUII, the process 1010, continues to step 1018, in which the user and any appropriate third parties may be notified of a potentially counterfeit product.

From step 1014, when the UUII is determined to be a valid UUII, it is next determined whether the UUII has been previously submitted for authentication by this or another user (step 1015). If so, the UUII is considered invalid. This is because all UUIIs are unique codes that can never be re-used from product to product, and since a counterfeiter may attempt to copy UUIIs from other products and repeatedly use them, for example. In such case of a duplicate UUII submission, the process 1010 continues to step 1018, in which the user and any appropriate third parties may be notified of a potentially counterfeit product. Otherwise, if the UUII has not been submitted before for authentication, the process 1010 continues to step 1016 below.

Next, at step 1016, any information entered by the user to identify the product (other than the UUII), such as SKU, UPC, serial number, batch code, or the like, is compared to the product code of the product to which the UUII was applied. Only when the UUII and product information as submitted by the user matches the stored UUII and product identifier information in the database, and only when the UUII has not been previously submitted, will the UUII be finally determined as valid (step 1017). Otherwise, when the submitted product information does not match the stored product information, the process 1010 continues to step 1018, in which the user and any appropriate third parties may be notified of a potentially counterfeit product. After either steps 1017 or 1018 above, the process 1010 ends.

It should be appreciated that at or after step 1018, the process 1010 may include requiring the user to submit further specific information so that the locations where counterfeited products were purchased may be readily identified. Other additional steps may likewise be taken, such as notification of manufacturers, distributors law enforcement, or any third party of the detection of counterfeited products.

By empowering millions of consumers to help police the prescription drug supply, the methods of authentication described herein offer a more effective overall solution. It dramatically lowers costs (from sales lost to counterfeit products) and liability (e.g., for pharmaceutical companies found responsible for the effects of a counterfeit drug), eliminates the cost of RFID tags and readers, reduces threat of lawsuits, and prevents loss of sales due to counterfeit drugs, which is currently estimated in the billions of dollars per year. The disclosed methods also reduce the liability and cost of insurance companies having to pay claims to patients who are not getting better because they are taking counterfeit medicine. Adaptation of the disclosed methods may even saves lives, by offering a reliable means by which fewer consumers will unwittingly take dangerous counterfeit drugs.

While the present disclosure mentions prescription drugs and pharmaceuticals in particular, it should be readily apparent that the methods herein may be applied to any of a wide variety of items and products, without limitation. While the present disclosure describes application of a UUII at one time, the UUII may be generated in parts separately, by separate parties and combined, for example, at a point of sale, after which the combined code is stored in a database. The use of UUIIs may be used in conjunction with RFIDs placed on products or as an alternative thereto. Various other equivalent steps may likewise be included in the disclosure provided herein.

In various embodiments, for increased security and safety, the UUIIs themselves may not be stored in a database as described in the foregoing. In such embodiments, the method 1010 instead uses a decoding algorithm to reverse-calculate the information encoded into UUIIs received from users. Once this reverse calculation is done, then the decoded information is matched against stored uncoded information relating to each UUII (e.g., what product it was affixed to, the location the product was made, and any other information that may be encoded into the UUII).

UUIIs are likewise useful for accomplishing secure transactions. The methods and systems for accomplishing financial payments now introduced, sometimes referred to herein as PRIVATECHECK, eliminates the security loopholes of paper checks, reduces the cost of transactions (e.g. handling paper checks, credit card fees, and the like), and protects the identity and sensitive information of small businesses. It is based on point-to-point transactions where verified payers and payees can make and receive payments to and from each other, respectively, without revealing checking account numbers, bank routing numbers, or other sensitive information usually presented on paper checks and the like.

Each transaction, including details necessary to effect the transaction (such as date and time, dollar amount, payer and payee parties, and transaction memos or notes) is uniquely identified by an identifier or code. Both parties can audit transactions for accuracy, using only the provided code, without ever requiring the underlying identity or bank information of the other party that appears on paper checks.

The PRIVATECHECK service eliminates the risk of fraud and identity theft of paper checks, reduces the cost of transactions (e.g. check fraud), and reduces costs due to human error. Any customer of a participating bank, financial institution or other service provide, can sign up for the service. Once verified, each customer receives a unique PRIVATECHECK identifier, which they use for making and receiving payments without revealing their sensitive banking information to payee parties. Each transaction is also uniquely identified with, for example, a single-use alphanumeric transaction code which can only be deposited by the intended payee, and is therefore of no use even if intercepted. Deposits are made by copy-and-paste of the transaction code by the payee, thus eliminating the human error associated with re-typing handwritten information from paper checks. Both parties can audit transactions for accuracy, using only the transaction code, without ever requiring the identity or bank information of the other party. Completed transactions can also be downloaded directly into standard accounting software such as QUICKEN or QUICKBOOKS.

The PRIVATECHECK service offers the following benefits: (i) registered and verified customers are uniquely identified by a PRIVATECHECK Customer Identifier, which can be designated for use only to receive payments, and can therefore be printed publicly on business cards or other publicly disseminated business information; (2) payments are made simply by specifying the payee's PRIVATECHECK Customer ID and the amount to pay, in response to which a unique, single use transaction code is created; and (3) deposits are made by entry of the transaction code and can only be deposited by the payee, when properly logged-in to the PRIVATECHECK SERVICE. The transaction code is tied to the intended payee in the records of the PRIVATECHECK service, and so can not be used by unintended parties, even if intercepted.

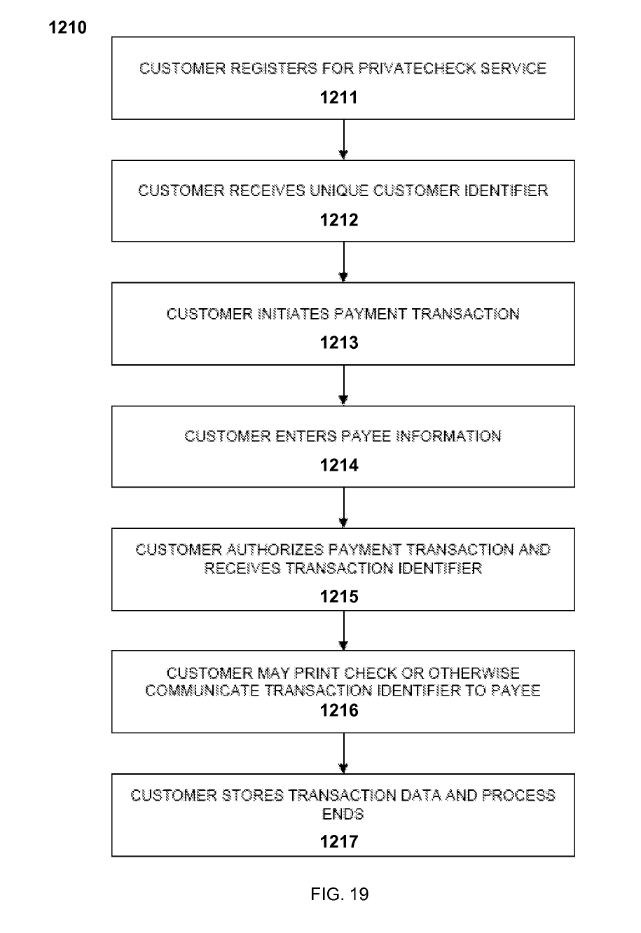

Turning now to FIGS. 19-23, therein are depicted exemplary flowcharts of the processes performed by payers and payees of financial transactions to accomplish a payment, and some exemplary screen shots for entering the information required by such processes. It should be readily apparent that such systems may be implemented over any sort of computer or telecommunications network that is suitable for accomplishing electronic communications and financial transactions, such as the Internet, or any other type of wired or wireless network as now known or hereafter developed. In performing the processes 1210, 1220, it should be readily apparent that the customers and any third party participants to the processes may communicate using any of a wide variety of well known computer systems that include processors, memory, inputs/outputs, communications ports, and appropriate hardware and software, such as operating instructions, applications, databases and processing instructions for accomplishing the functions described herein. Communications may in fact be accomplished by any electronic device that is useful to communicate electronic data over a suitable network, and may include cellular telephones, personal digital assistants, and the like, as now known or hereinafter developed.

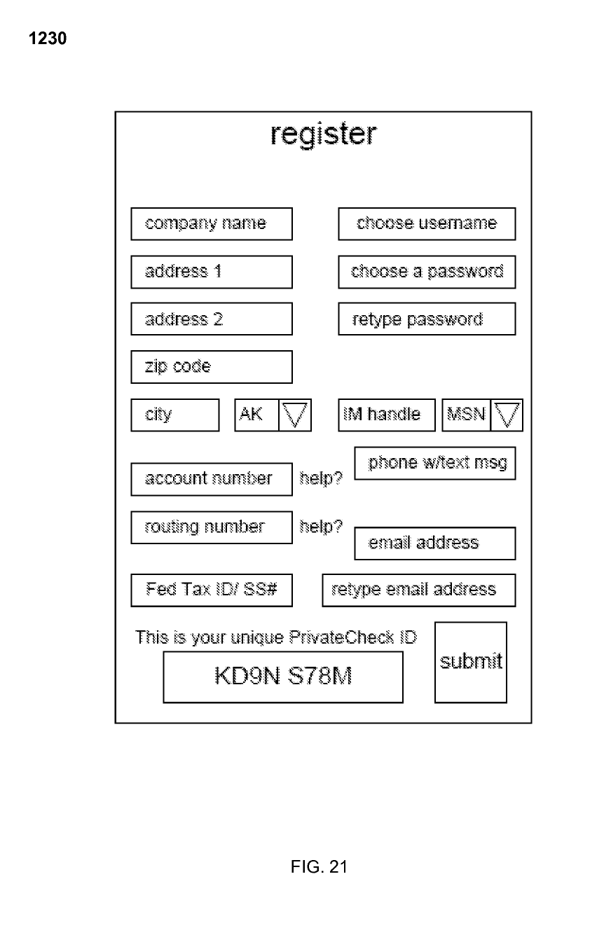

With reference to FIG. 19, therein is depicted an exemplary process 1210 for registering with the PRIVATECHECK service and initiating a payment transaction according to the present disclosure. The process 1210 commences when a customer registers with a provider of the PRIVATECHECK service described herein (step 1211). This may be accomplished by entering the information shown in the exemplary customer registration screen 1230 of FIG. 21. The customer enters their name (e.g., business or personal name), address (including postal and email addresses), business checking account number/bank routing number and other necessary bank account and personal/business information (such as taxpayer ID or social security number). The customer also selects a password for accessing and using the generated account.

Upon confirmation of the entered customer information (such as by the well-known techniques of confirming through communication via the customer's entered e-mail address and/or by independent credit checks and the like), the provider of the PRIVATECHECK service generates a unique identifier, such as a multi-digit alphanumeric code (example: KD9NS78M), preferably, but not limited to, a size of at least eight characters, which uniquely identifies the business and their account (step 1212), and which can not be re-used to identify other customers. In various embodiments, the customer identifier may be a universally unique identifier as described in co-pending U.S. patent application Ser. No. 10/653,391, the entirety of which is incorporated herein by reference. In such embodiments, or in varieties thereof, the customer identifier may be generated by encoding customer information or data associated with the registration of the customer, according to any of a variety of well-known encoding techniques now known or hereinafter developed. The code may be guaranteed to be universally unique by encoding a unique property of the customer registration information in the customer identifier as described in the referenced application.

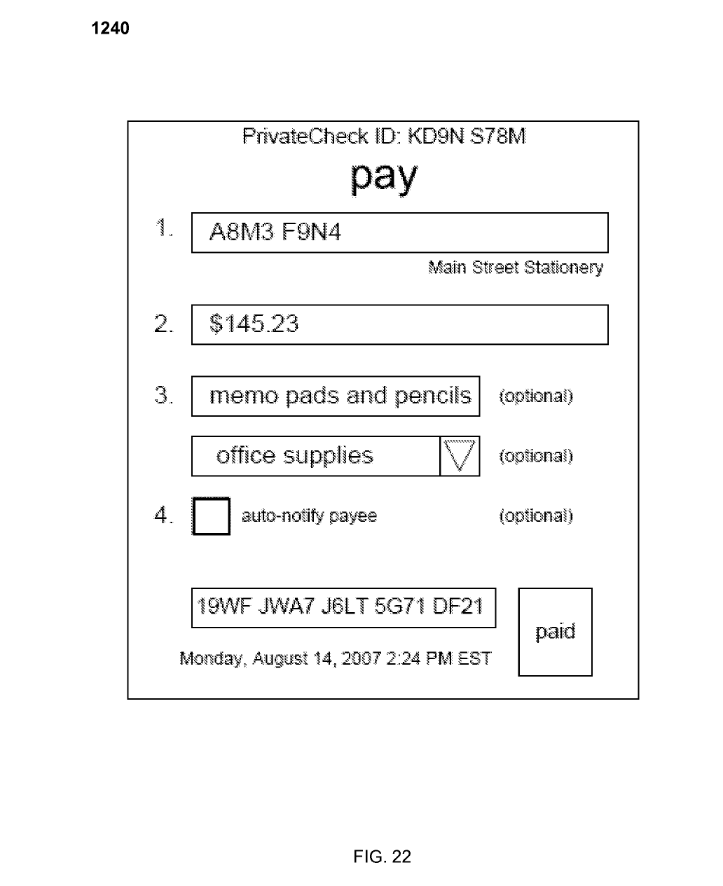

Returning to the process 1210, the customer may then initiate a payment transaction by first logging into a website of the PRIVATECHECK service of the like, entering their customer identifier and password (step 1213), and selecting a “make payment” (or similarly identified) function. The customer may then be presented with an exemplary transaction initiation screen 1240, as depicted in FIG. 22.

Next, at step 1214, the customer enters in similar information that they would typically use for a paper check, namely, a payee, a payment amount and notes or memoranda concerning the payment, and may also select to automatically notify (by e-mail or the like) the payee of the initiated transaction. It should be noted that, unlike the information on a paper check, the payee information will comprise a customer identifier of the payee, which is the payee's unique alphanumeric identifier that may also assigned to the payee in the manner described above with respect to step 1212.

Upon confirmation of the entered transaction information, the customer selects a function by which the transaction is authorized and executed, upon which a unique transaction identification code is generated by the provider of the PRIVATECHECK service (step 1215). Namely, the PRIVATECHECK service generates a unique (preferably, but not limited to, 12-20 digits) alphanumeric transaction identification code (e.g., 19WFJWA7J6LT5G71DF21), which uniquely identifies that particular transaction and is tied only to the payee's customer identifier so that other parties can not intercept and use the transaction code for their own accounts. In various embodiments, the transaction identifier may be a universally unique identifier (UUI) as described in co-pending U.S. patent application Ser. No. 10/653,391, the entirety of which is incorporated herein by reference. In such embodiments, or in varieties thereof, the transaction identifier may be generated by encoding payer, payee, or transaction information, according to any of a variety of well-known encoding techniques now known or hereinafter developed. The code may be guaranteed to be universally unique by encoding a unique property of the transaction data, as described in the referenced application, such as: date/time, payer/payee code, transaction amount, memoranda or note information, Internet Protocol (IP) address of the initiating party, session identifier (ID) of the initiating party, and the like).

Next, at step 1216, the customer communicates the transaction identifier to the payee. In one embodiment, the customer may print a check that includes the transaction identifier in place of bank/routing number on an otherwise standard paper check. The customer may have the PRIVATECHECK service automatically notify the payee of the transaction identifier by e-mail or the like, or may otherwise communicate the transaction identifier to the payee themselves.

Finally, at step 1217, the customer may download the transaction data directly to their accounting software or enter the same in any of a variety of useful and well-known manners, after which the process 1210 ends.

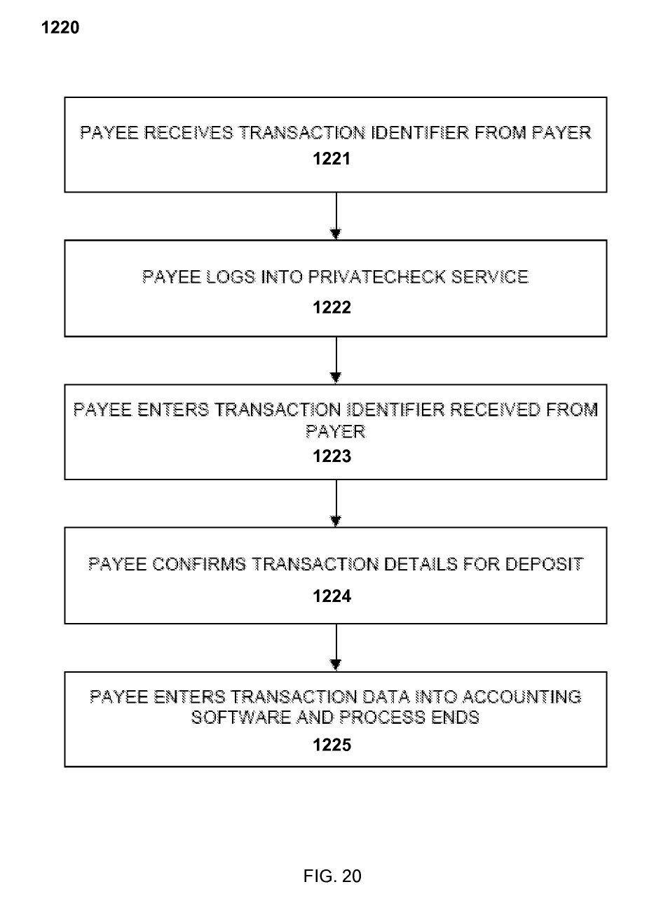

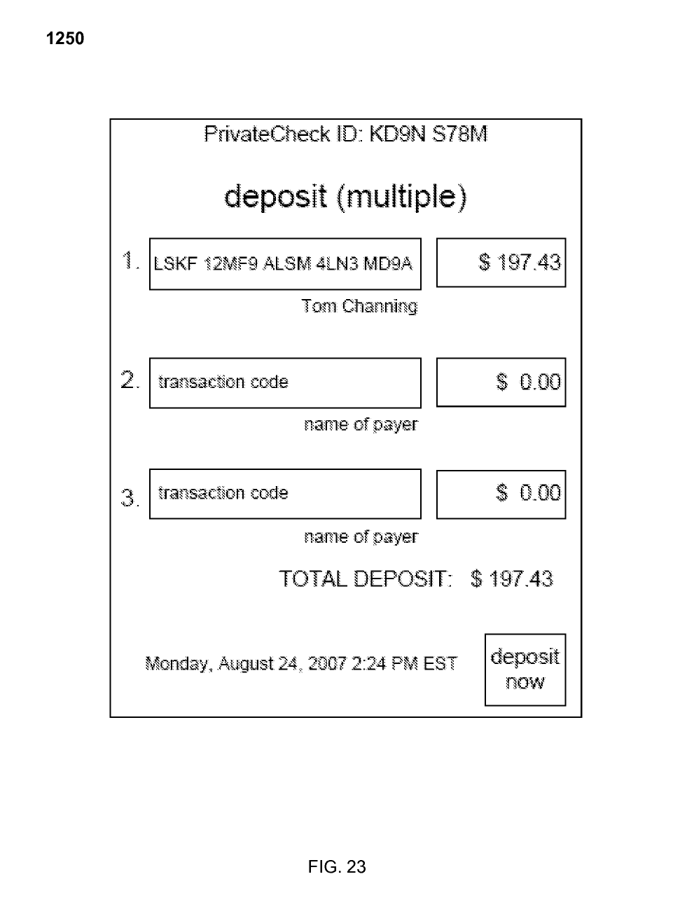

Turning now to FIG. 20, therein is depicted an exemplary process 1220 performed by a payee for entering a deposit via the PRIVATECHECK SERVICE. The process 200 begins when a payee receives a transaction identifier from a payer (step 1221). The payer logs into the PRIVATECHECK service using their customer identifier (generated in the manner described for step 1212 above) and password (step 1222), and selects a “deposit” (or similarly identified function). The payee may then be presented with an exemplary deposit screen 1250, as depicted in FIG. 23. The payee needs only enter therein the received transaction code (step 1223), and if the PRIVATECHECK service confirms that the transaction identifier corresponds to the payee entering the same, the payee is asked to verify the transaction information (such as payer, transaction amount, memo, and the like) presented by the PRIVATECHECK service form the records for the transaction. Next, at step 1224, the payee confirms the deposit, and downloads or otherwise enters the completed transaction into their accounting software (step 1225), after which the process 1220 ends.

The PRIVATECHECK service accomplishes actual payment by processing a financial transfer of funds from the underlying actual bank account of the payer to the actual underlying bank account of the payee, as stored during the registration processes of both parties. The funds transfer may be accomplished using well known Automatic Clearing House (ACH) payment networks, or the like, as now known or hereinafter developed.

For small business owners and accountants who write and deposit numerous paper checks monthly, PRIVATECHECK is a secure, electronic payment service that provides privacy, accuracy, and time/cost savings that bank wires, credit cards, or check cards cannot provide. PRIVATECHECK provides the complete digital alternative to paper checks and fits within current small business payment processes.

Providers of the PRIVATECHECK service, such as banks, financial institutions, or other third parties, may offer free “check replacement” to customers for a flat fee per transaction, in order to encourage participation in the PRIVATECHECK service. PRIVATECHECK may be an application service provider to banks who pay licensing fees to be able to offer the PRIVATECHECK feature to their customers. PRIVATECHECK may also charge a flat transaction fee per transaction to the party making payment for the privacy protection. The provider of the PRIVATECHECK service may earn interest on the “float” of funds between the time payment is made and the time that the payee makes the deposit and this withdraws funds into their own bank account.

In sum, the PRIVATECHECK service described herein may provide the following benefits: (1) privacy, in that neither party to a transaction has to reveal their checking account number or bank routing number to the other; (2) accuracy, in that the unique customer identifiers eliminate many errors due to misspellings of payee name and the like, because PRIVATECHECK double checks that the payee entering in the transaction code is indeed the same as the payee intended by the payer, and the transaction code may incorporate this confirming information; (3) convenience, in that it is easy to write the check by typing in information (same fields of info as a regular check, except the payee field is filled in with the 8-digit identifier of the payee instead of the name of the business); (4) speedy deposit, in that there are no paper checks to endorse and deposit physically at the bank; (5) cost effective, in that a flat fee per transaction can be offered, there is no more handling paper checks, and payees can make deposits by entering in transaction code online in either case; and (5) data may be easily downloaded into customer's existing accounting software from the PRIVATECHECK service.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A web server system connected to at least one network for securely processing a financial transactions, comprising:
a data store having personal data of a customer and a mobile device address corresponding to a mobile communications device of the customer;
a data communications network exchange for receiving a request from a the customer to enable a self-authentication procedure for a payment instrument of the customer using the mobile communications device;
a financial transaction network exchange for receiving an indication of a transaction involving the payment instrument of the customer after the self-authentication procedure is enabled;
a processor for randomly selecting one of a plurality of security questions based on the personal data of the customer in the data store; and
transmitting the security question to mobile device address of the mobile communications device of the customer during the transaction via a communications network exchange, and only after the customer transmits a correct response to the randomly-selected security question from the mobile communications device to the processor during the transaction, the processor generates and transmits an authorization code for the transaction via the financial transaction network exchange, the authorization code comprising a universally unique identifier (UUI) that is determined by the processor by generating a pseudo-random number and encoding the pseudo-random number with an indication of a time corresponding to the authorization of the transaction, such that the authorization code is unique and includes an encoded indication of at least the time, which may be used to subsequently verify the transaction and prevent fraud.

2. The system of claim 1, wherein the payment instrument comprises at least one of a credit account and a debit account.

3. The system of claim 1, wherein the point of contact mobile device address comprises a mobile telephone number of the customer.

4. The system of claim 1, wherein the indication is received from a merchant over a computer network via a financial transaction network.

5. The system of claim 1, wherein the personal data of the customer used for the security question comprises at least one of:
a first name, a middle name, a last name, a street address, a house number, a zip code, a primary home telephone number, a daytime or work telephone number, a cellular or satellite telephone number, an electronic mail address, an instant messaging address, a social-security number, and a date of birth of the customer.

6. The system of claim 1, wherein the UUI authorization code further includes an encoded indication of at least one of: a location of a transaction, a merchant name, a merchant type, a product identifier and a store identifier corresponding to the transaction.

7. The system of claim 1, wherein the pseudorandom number is generated by selecting non-random number sequences.

8. A method for verifying a financial transaction between a merchant having a merchant server and a customer having a personal communication device, the method comprising:
receiving, from a merchant server via a network communication interface, an indication of an initiated financial transaction involving the customer and the merchant, the customer having a financial account from which a payment to the merchant may be validated by the financial transaction computer server;
retrieving, from a data store, a stored question for which a correct response has been previously provided by the customer and further retrieving a communications address corresponding to the personal communication device of the user;
while the initiated financial transaction is pending, transmitting the stored question to the personal communication device of the customer via a communications network;
receiving, from the personal communications device, a response to the question;
comparing the received response to the correct response; and
authorizing the transaction when the received response corresponds to the correct response by transmitting an authorization code to the merchant server over the network communication interface, where the authorization code comprises a universally unique identifier (UUI) that is determined by generating a reference data referencing the transaction and encoding the reference data with an indication of a time corresponding to the authorization of the transaction, such that the authorization code is non-repetitive and includes an encoded indication of at least the time, which may be used to subsequently verify the transaction and prevent fraud.

9. The method of claim 8, wherein when the received response does not correspond to the correct response, the financial transaction computer server transmits a second question having a second stored correct response to the personal communication device of the user.

10. The method of claim 8, wherein when the received response does not correspond to the correct response, the financial transaction computer server transmits a second question having a second stored correct response a second device associated with the customer before said authorizing.

11. The method of claim 8, wherein the UUI used for authorization of the financial transaction is not repeated in future financial transactions.

12. The method of claim 8, wherein after a plurality of incorrect responses are received from the personal communication device than the transaction is not authorized.

13. A computerized system for completing a financial payment transaction by a customer using a payment instrument, comprising:
a communication interface for communicating with computing devices over a computer network;
a data store for maintaining personal data to of a customer of a financial institution that is associated with a payment instrument used by the customer, the personal data comprising at least one of the following items: a first name, a middle name, a last name, a street address, a house number, a zip code, a primary home telephone number, a daytime or work telephone number, a cellular or satellite telephone number, an electronic mail address, an instant messaging address, a social-security number, and a date of birth of the customer;
the data store further storing a personal identification number (PIN) and a password of the customer that is separate from the personal data of the customer;
the data store further storing a mobile device address corresponding to a mobile communications device of the customer;
a processor programmed by suitable processing instructions for:
designating a point of contact for the payment instrument; and thereafter:
receiving a request from the customer to enable a self-authentication procedure for a payment instrument of the customer using the mobile communications device;
entering into a transaction involving the payment instrument;
randomly selecting one of a plurality of security questions based on the personal data of the customer in the data store and, in response to the indication, transmitting the security question to mobile device address of the mobile communications device of the customer during the transaction
transmitting a communication to the point of contact during the transaction, the communication including a security question that is based on a randomly-selected item of the personal data; and
receiving correct personal data in a response to the security question via the point of contact, thereby self-authenticating the transaction prior to an authorization of the transaction by the financial institution, and
only after the customer transmits a correct response to the randomly-selected security question from the mobile communications device to the processor during the transaction, the processor then generates and transmits an authorization code for the transaction via the financial transaction network exchange,
wherein the authorization code comprising a universally unique identifier (UUI) that is determined by the processor which generates a pseudo-random number and encodes the pseudo-random number with an indication of a time corresponding to the authorization of the transaction, such that the authorization code is unique and includes an encoded indication of at least the time, which may be used to subsequently verify the transaction and prevent fraud.
